(19) United States
(12) Patent Application Publication
(10) Pub. No.: US 2026/0129702 A1
(43) Pub. Date: May 7, 2026

(54) Systems and Methods for Improved Triggered Uplink Access

(71) Applicant: Cisco Technology, Inc., San Jose, CA (US)

(72) Inventors: Malcolm Smith, Richardson, TX (US); Binita Gupta, San Diego, CA (US); Brian Hart, Sunnyvale, CA (US)

(21) Appl. No.: 19/378,077

(22) Filed: Nov. 3, 2025

Related U.S. Application Data
(60) Provisional application No. 63/716,152, filed on Nov. 4, 2024.
(60) Provisional application No. 63/716,141, filed on Nov. 4, 2024.

(51) Int. Cl. H04W 76/15; H04W 72/21

(52) U.S. Cl. CPC H04W 76/15

(57) ABSTRACT

Systems, devices, and methods for improving triggered uplink access in wireless networks are disclosed. In some embodiments, a leader access point (AP) in a multi-AP coordination group exchanges coordinated triggered uplink access (C-TUA) capabilities with a follower AP and coordinates an uplink transmission time. The leader AP receives device information from the follower AP and transmits a proxy trigger frame on behalf of the follower AP, instructing the follower's associated wireless devices to transmit uplink data directly to the follower AP. In further embodiments, an AP establishes a triggered uplink access (TUA) group for multiple devices with similar predictable traffic. The AP transmits a group announcement with a group identifier (GID) and shared uplink parameters. Subsequently, the AP transmits a compressed, enhanced trigger frame comprising the GID and omitting per-wireless device user information to efficiently trigger the entire group.

### PRIORITY/CROSS-REFERENCE TO RELATED APPLICATIONS

This application claim benefit of and priority to both U.S. Provisional Application No. 63/716,152 filed Nov. 4, 2024 and U.S. Provisional Application No. 63/716,141, filed Nov. 4, 2024, wherein the entirety of each are incorporated herein by reference.

The present disclosure relates to network protocol management. More particularly, the present disclosure relates to optimizing triggered uplink access in wireless networks through multi-access point coordination using proxy triggers and through trigger frame compression using group identifiers.

### BACKGROUND

Wireless local area networks (WLANs) have become ubiquitous, providing connectivity for a vast array of devices in homes, enterprises, and public spaces. Standards such as those defined by the Institute of Electrical and Electronics Engineers (IEEE) 802.11 working group, commonly known as Wi-Fi, continue to evolve to meet the increasing demands for higher throughput, lower latency, and greater capacity. As more devices rely on wireless connections for communication, managing network resources efficiently becomes increasingly critical to maintain performance and user satisfaction.

A key aspect of wireless network management involves coordinating how and when different wireless devices transmit data, particularly in the uplink direction (from the wireless device to the access point). Without effective coordination, simultaneous transmissions from multiple devices can lead to collisions, resulting in corrupted data, retransmissions, increased latency, and reduced overall network efficiency. Various mechanisms have been developed over time to schedule or grant access to the wireless medium, aiming to allocate resources fairly and efficiently among competing devices.

The proliferation of diverse applications places further demands on wireless networks. Beyond traditional data applications like web browsing and email, networks now support real-time communication services such as high-definition video conferencing, interactive gaming, virtual and augmented reality (XR), and numerous Internet of Things (IoT) devices, including industrial sensors and controllers. Many of these emerging applications have stringent requirements for low latency, high reliability, and predictable performance, pushing network designers to develop more sophisticated access control and quality of service (QoS) mechanisms.

Furthermore, wireless deployments are often characterized by high density, with numerous wireless devices and multiple access points operating in close proximity. In such environments, interference between different networks or different access points within the same network can degrade performance. Effective coordination strategies between access points may be employed to mitigate interference and optimize the use of shared wireless spectrum, thereby improving capacity and reliability across the deployment area.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 illustrates a single-access point network environment in accordance with various embodiments of the disclosure;

FIG. 2 illustrates a multi-access point use case scenario in accordance with various embodiments of the disclosure;

FIG. 3 illustrates a multi-access point network environment depicting a proxy trigger transmission in accordance with various embodiments of the disclosure;

FIG. 4 illustrates an overlapping coverage areas in a multi-access point environment in accordance with various embodiments of the disclosure;

FIG. 5 illustrates a system diagram for coordinated triggered uplink access operation in accordance with various embodiments of the disclosure;

FIG. 6 illustrates a block diagram of an enhanced triggered uplink access trigger frame in accordance with various embodiments of the disclosure;

FIG. 7 is a flowchart showing a process for access point operation of enhanced triggered uplink access groups in accordance with various embodiments of the disclosure;

FIG. 8 is a flowchart showing a process for a leader access point performing coordinated triggered uplink access in accordance with various embodiments of the disclosure;

FIG. 9 is a flowchart showing a process for a follower access point participating in coordinated triggered uplink access in accordance with various embodiments of the disclosure;

FIG. 10 is a flowchart showing a process for a wireless device receiving triggered uplink access triggers in accordance with various embodiments of the disclosure; and

FIG. 11 is a conceptual block diagram for one or more network devices capable of executing components and logic for implementing the functionality and embodiments described herein in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

### Overview

In some embodiments, an access point, includes a processor, at least one network interface controller configured to provide access to a network, and a memory communicatively coupled to the processor, wherein the memory includes a coordinated triggered uplink access (C-TUA) logic. The logic is configured to exchange, via the network interface controller, one or more C-TUA capabilities with a second, follower access point (AP) within a multi-AP coordination (MAPC) group, coordinate an uplink transmission time associated with a service period (SP) of the second, follower AP, receive, from the second, follower AP, information identifying at least one wireless device associated with the second, follower AP, and transmit a proxy trigger frame on behalf of the second, follower AP at the uplink transmission time.

In some embodiments, an access point includes a processor, at least one network interface controller configured to provide access to a network, and a memory communicatively coupled to the processor, wherein the memory includes a coordinated triggered uplink access (C-TUA) logic. The logic is configured to: establish a triggered uplink access (TUA) group including a plurality of wireless devices, transmit, via the network interface controller, a group announcement message defining uplink parameters for the TUA group, and transmit, via the network interface controller, an enhanced trigger frame including a group identifier (GID) for the TUA group.

In some embodiments, a method of access point (AP) coordination includes exchanging, via a network interface controller, one or more C-TUA capabilities with a follower access point (AP) within a multi-AP coordination (MAPC) group, coordinating an uplink transmission time associated with a service period (SP) of the follower AP, receiving, from the follower AP, information identifying at least one wireless device associated with the follower AP, and transmitting a proxy trigger frame on behalf of the follower AP at the uplink transmission time.

### Example Embodiments

The issues described above highlight a need for a more efficient and scalable system for managing triggered uplink access in dense wireless network environments. The overhead associated with both individual trigger frames for frequent, low-data applications (such as extended reality or industrial internet of things traffic) and the coordination between multiple access points (APs) in close proximity can create significant latency and inefficiency. Embodiments of the present disclosure provide a unified solution, which may be implemented by a coordinated triggered uplink access (C-TUA) logic on a network device, to address these inefficiencies at both the single-AP (intra-BSS) and multi-AP (inter-BSS) levels. This solution may comprise, in various embodiments, an enhanced grouping mechanism to compress trigger frames for an individual AP, and a coordinated proxy triggering mechanism to reduce overhead between APs in a multi-AP coordination (MAPC) group.

At the single-AP level, the C-TUA logic may be configured to establish a triggered uplink access (TUA) group, which comprises a plurality of wireless devices determined to have similar, predictable traffic characteristics. This determination may be based on explicit signaling from the devices, such as stream classification service (SCS) quality of service characteristics (QC) signaling, or may be based on learned traffic periodicity, potentially identified by a machine-learning model. After establishing the group, the C-TUA logic may transmit a group announcement message to the member wireless devices, which defines common uplink parameters such as a fixed service interval (SI), a pre-allocated resource unit (RU), or a specific modulation and coding scheme (MCS). This pre-negotiation allows the AP to subsequently transmit a single, highly efficient enhanced trigger frame that comprises a group identifier (GID) and omits the repetitive per-wireless device user information, thereby significantly reducing overhead for each trigger event.

In dense deployments, the C-TUA logic may be configured to establish or join a multi-AP coordination (MAPC) group with other neighboring access points. Within this group, an AP may operate as a leader AP, configured to coordinate an uplink transmission time, often associated with a service period (SP), with a second, follower AP. The leader AP may receive information from the follower AP identifying at least one wireless device associated with that follower AP that requires triggering. At the coordinated time, the leader AP may then transmit a proxy trigger frame on behalf of the follower AP, which instructs the follower's wireless device to transmit its uplink data directly to the follower AP. This proxy mechanism avoids the high overhead of standard AP-to-AP coordination protocols, which could otherwise involve multiple control frame exchanges, by replacing the multi-frame handoff with a single, direct trigger from the leader.

These two mechanisms may be combined to provide a comprehensive optimization as part of a single, unified system. A follower AP may first establish its own enhanced TUA group and assign it a GID, as described above. When coordinating with a leader AP, this follower AP may provide the GID as the “information identifying at least one wireless device”, and the APs may exchange capabilities indicating support for GID-based triggering. The leader AP may then transmit a proxy trigger frame that is also an enhanced trigger frame, comprising the follower's GID and omitting per-wireless device user information. This synergistic approach allows the leader AP to trigger an entire group of a follower's wireless devices with a single, highly compressed control frame, maximizing efficiency at both the inter-AP and intra-AP levels.

For such a system to operate, wireless devices may also support aspects of the C-TUA protocol, and APs may exchange detailed C-TUA capabilities. A wireless device associated with a follower AP may need to be configured to accept and validate a proxy trigger frame originating from a non-associated (leader) AP. This validation may be based on the proxy trigger frame using a specific, shared MAPC coordination group (CG) address as its transmitter address, which the follower AP provides to its wireless devices. Furthermore, the C-TUA logic on the leader AP may be configured to use advanced techniques, such as coordinated spatial reuse (C-SR), to transmit proxy trigger frames simultaneously to wireless devices associated with two or more different follower APs in a single transmission opportunity.

In various embodiments, the establishment of a triggered uplink access (TUA) group may be initiated by a wireless device operating as a group leader, rather than by the access point (AP) itself. For example, a group leader wireless device may transmit a stream classification service (SCS) request to its associated AP, where the request indicates a desire to form a TUA group on behalf of itself and other member wireless devices. The AP, in response, may negotiate the group parameters with the group leader wireless device and assign a group identifier (GID). In such embodiments, the group leader wireless device may then be responsible for distributing the GID and the associated group parameters to the other wireless devices that are members of that TUA group.

Furthermore, the uplink parameters defined in the group announcement message, particularly the resource unit (RU) allocation, may be implemented in several ways. In some embodiments, the AP may define a specific, fixed RU allocation for each member of the TUA group and communicate this individual allocation to each device during the group announcement. In alternative embodiments, the AP may allocate a single, larger RU (e.g., a 40 MHz RU) to the TUA group identifier (GID) as a whole. In this scenario, the plurality of wireless devices within the TUA group may then be responsible for self-coordinating or managing the sub-division of that allocated RU amongst themselves, such as in a peer-to-peer (P2P) manner within the group, without the AP managing each member's specific sub-allocation.

In embodiments involving coordinated triggered uplink access (C-TUA) within a multi-AP coordination (MAPC) group, support for control frame protection for proxy trigger frames may be implemented via different key management strategies. In one embodiment, a single common key may be defined and shared across all APs within the MAPC group and also distributed to all associated wireless devices participating in C-TUA. Alternatively, each AP in the MAPC group may possess its own distinct key for control frame protection; in this embodiment, each AP would exchange its key with the other APs in the MAPC group, and those other APs would then be responsible for securely sharing that key with their own associated wireless devices that support the C-TUA operation.

While some group-based triggering mechanisms may be known in other contexts, such as peer-to-peer (P2P) communications, embodiments of the present disclosure are directed toward infrastructure-based uplink transmissions. The enhanced TUA (E-TUA) and coordinated TUA (C-TUA) systems described herein may involve an infrastructure device, such as an access point (AP), initiating the group trigger. Specifically, in a C-TUA embodiment, a leader AP transmits a proxy trigger frame to instruct a wireless device (or group of devices) to transmit its uplink data not to another peer device, but to the infrastructure, specifically to its associated follower AP.

As those skilled in the art will recognize, Triggered Uplink Access (TUA) and Triggered Uplink Access Optimization (TUA-O) may refer to mechanisms, such as those defined in Wi-Fi 6 and Wi-Fi 7 respectively, which allow an access point to schedule uplink transmissions from wireless devices. TUA-O, for example, may combine Stream Classification Service (SCS) Quality of Service (QoS) Characteristics with triggering, enabling an AP to send a Trigger frame to a set of devices based on their known service interval (SI) or period. A key aspect of this operation is that the AP may not need to issue a Buffer Status Report Poll (BSRP) before scheduling the trigger, which can reduce overhead and improve reliability.

In various embodiments, Coordinated Triggered Uplink Access (C-TUA) may refer to a multi-AP coordination system, such as that implemented by the coordinated triggered uplink access logic. C-TUA operation may allow a designated leader AP within a coordination group to transmit a trigger frame on behalf of a follower AP. This coordination may be used to efficiently schedule uplink transmissions for wireless devices associated with the follower AP without requiring the follower AP to contend for the medium to send its own trigger, thereby reducing coordination overhead.

A Multi-Access Point (AP) Coordination (MAPC) Group, which may also be referred to as a Coordination Group (CG), may represent a set of APs that have agreed to coordinate their transmissions. This group may be defined within the scope of an Extended Service Set (ESS) or as a more localized coordination group, such as neighboring co-channel APs. Within the MAPC group, APs may exchange capabilities, such as C-TUA capabilities, and negotiate shared transmission schedules, such as service periods (SPs), to mitigate interference and improve efficiency.

As utilized herein, a Leader AP may refer to an access point within a MAPC group that is configured to initiate and transmit a proxy trigger frame on behalf of one or more other APs. A Follower AP may refer to an AP within the group that receives coordination from a leader AP. The follower AP may provide information identifying its associated wireless devices to the leader AP, and is the AP that receives the uplink data from its wireless devices after they are triggered by the leader AP's proxy trigger frame.

A Proxy Trigger Frame may refer to a trigger frame transmitted by a leader AP that instructs at least one wireless device associated with a different (e.g., follower) AP to transmit uplink data. This proxy trigger frame may be transmitted on behalf of the follower AP and may contain an identifier corresponding to the wireless device(s) associated with that follower AP. In some embodiments, to ensure the wireless device accepts the frame, the proxy trigger frame may use a shared MAPC coordination group (CG) address as its transmitter address.

The term Enhanced Triggered Uplink Access (E-TUA) may refer to an optimization of the TUA mechanism. This enhancement may be designed to improve efficiency, particularly for high-frequency, low-data applications like XR or IIOT. The E-TUA optimization may involve establishing TUA groups and transmitting a compressed or enhanced trigger frame that uses a group identifier (GID) in place of repetitive, individual per-wireless device user information.

A Triggered Uplink Access (TUA) Group may refer to a plurality of wireless devices that are established by an AP to be triggered simultaneously as a single unit. The C-TUA logic may establish this group based on identifying wireless devices with similar, predictable traffic characteristics, such as from received SCS QC signaling or learned traffic periodicity. Once established, the group may be assigned a single group identifier (GID) and may operate based on predefined uplink parameters, such as a fixed service interval (SI) or a fixed resource unit (RU) allocation for its members.

A Group Identifier (GID) may refer to a specific identifier assigned by an AP to a TUA group. This GID may be used as the destination identifier in an enhanced trigger frame, allowing the AP to trigger all members of the plurality of wireless devices in the group with a single, compressed frame. In various embodiments, the GID may be an identifier selected from the standard association identifier (AID) space managed by the AP. In a C-TUA context, this GID may be shared with a leader AP to allow for proxy triggering of the entire group.

An Enhanced Trigger Frame, also referred to as a Compressed Trigger Frame, may refer to the specific frame format used for E-TUA operation. This frame may be characterized by the inclusion of a TUA group ID instead of individual per-wireless device user information, thereby omitting that information and significantly reducing frame overhead. In some embodiments, the enhanced trigger frame may also include a compressed common info field.

As may be understood by those skilled in the art, Stream Classification Service (SCS) Quality of Service (QoS) Characteristics (QC) may refer to information signaled by a wireless device to an AP. This signaling may be used to precisely specify the traffic characteristics of an uplink flow, such as its predictable service interval, data rate requirements, and delay bounds. The C-TUA logic may utilize this explicit SCS QC signaling as a basis for identifying suitable wireless devices and establishing a TUA group.

A Service Interval (SI) may refer to the known period or frequency of a predictable traffic flow. For example, a 60 frames-per-second video application may have an SI of 16.67 ms. For emerging applications like XR pose or IIOT controls, this SI may be much shorter, such as 1-5 ms. The C-TUA logic may establish a TUA group based on wireless devices sharing a similar, firm-fixed SI, which may be defined in the group announcement message.

A Service Period (SP), in the context of multi-AP coordination, may refer to a negotiated interval of time allocated for transmissions within a MAPC group. A leader AP and a follower AP may coordinate an uplink transmission time associated with an SP for the follower AP. This SP may be defined by parameters such as a Target Traffic Start Time (TTST) or a Start Time Protection Rule (STPR).

An Association Identifier (AID) may refer to a unique identifier, such as an association identifier, that an AP assigns to a wireless device upon its successful association with the AP. This AID is commonly used in management and control frames to identify the device. In various embodiments, the TUA group GID may be an identifier selected from the available AID space. In C-TUA operation, a follower AP may provide the AIDs of its wireless devices to the leader AP, which then includes these AIDs in the proxy trigger frame.

A Resource Unit (RU) may refer to a specific allocation of frequency and time resources within an Orthogonal Frequency-Division Multiple Access (OFDMA) transmission. An AP may assign a specific RU to a wireless device for its uplink transmission in a trigger frame. In an E-TUA embodiment, the group announcement message may define a fixed RU allocation for each member of the TUA group, or a single RU for the group, which is then stored in the TUA group data. The wireless device then transmits on this assigned RU after receiving the enhanced trigger frame.

A Target Traffic Start Time (TTST) may refer to a specific, coordinated time at which a traffic flow or transmission is scheduled to begin. In an E-TUA embodiment, TUA triggers may be aligned with the TTST of a flow. In a C-TUA embodiment, APs within a MAPC group may negotiate and share TTST information as part of their service period (SP) sharing arrangement. A follower AP, for instance, may know its own TTST and activate its receiver at that time to capture uplink data triggered by a leader's proxy trigger frame.

As may be understood by those skilled in the art, Coordinated Spatial Reuse (C-SR) may refer to a technique where multiple transmissions are allowed to occur simultaneously in the same frequency band, provided they are spatially separated enough to not cause undue interference. In various embodiments, a leader AP may utilize C-SR to enhance efficiency within the MAPC group. For example, the C-TUA logic may be configured to transmit a proxy trigger frame simultaneously to wireless devices associated with a second follower AP and wireless devices associated with a third follower AP using C-SR.

A Basic Service Set (BSS) may refer to the set of wireless devices associated with a single access point. The Basic Service Set Identifier (BSSID) is a unique identifier, typically the MAC address of the AP, that names the BSS. In a C-TUA embodiment, a follower AP may share the BSSIDs of other authorized leader APs in the MAPC group with its associated wireless devices. This allows a wireless device to validate and accept a proxy trigger frame originating from a BSSID other than its own associated AP's BSSID.

As those skilled in the art will recognize, Target Wake Time (TWT) may refer to a power-saving mechanism that allows an AP and a wireless device to negotiate a schedule for future communication, permitting the device to sleep in the interim. In various embodiments, the TUA mechanism may be aligned with TWT operations. For example, a TUA group established by the C-TUA logic may be associated with a broadcast TWT group, using the TWT schedule for coarse-grained alignment and power saving, and then using the enhanced TUA trigger frame at the actual wake time for the fine-grained uplink transmission.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

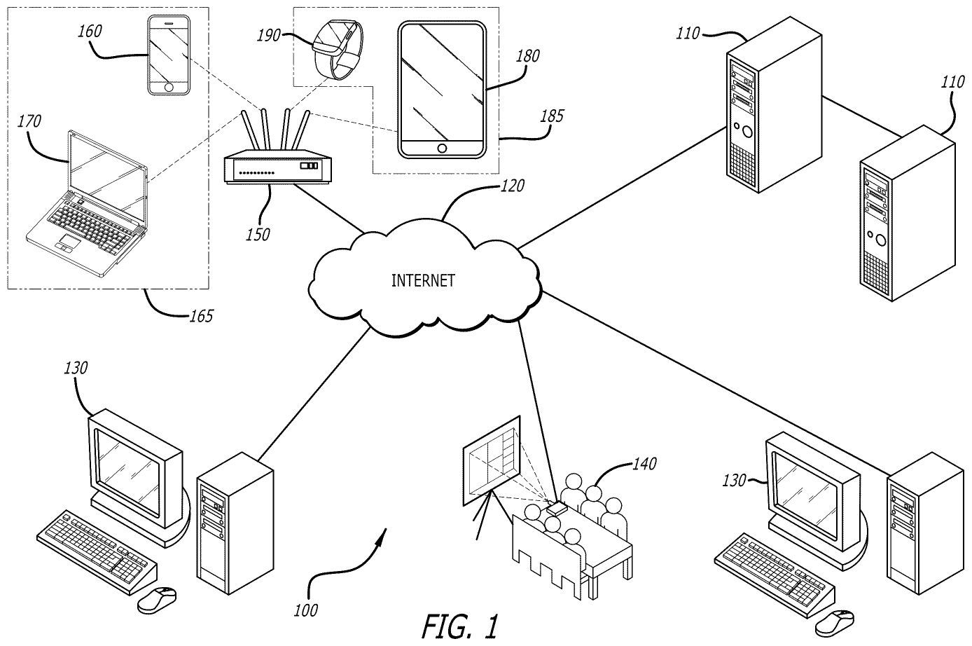

Referring to FIG. 1, an example single-access point network environment, in accordance with various embodiments of the disclosure is shown. The environment 100 may comprise a wireless local area network (WLAN) wherein a plurality of wireless devices 160, 170, 180 may communicate with other network devices, such as servers 110 or computers 130, via a network such as the Internet 120. This environment 100 may represent an enterprise, home, or industrial setting where efficient wireless communication is desired. In some embodiments, the environment 100 may include a single access point 150 managing wireless traffic, as depicted, which may be suitable for implementing an enhanced triggered uplink access (E-TUA) system. In other embodiments, the environment 100 may represent a dense deployment with multiple access points operating in close proximity necessitating coordinated triggered uplink access (C-TUA) mechanisms to manage channel access and reduce interference.

The environment 100 may include one or more servers 110. These servers 110 may host applications or services (e.g., video conferencing, cloud gaming, industrial control servers) that are accessed by wireless devices 160, 170, and 180. The traffic generated by these services, particularly uplink data from the wireless devices to the servers 110, may be predictable and periodic, making it suitable for optimization. For example, an industrial control application hosted on a server 110 might require periodic uplink pose data from an extended reality (XR) device 180, which can be managed by a triggered uplink access (TUA) group.

An access point 150 and other network components may be connected to a wider network, such as the internet 120. The internet 120 may facilitate communication between wireless devices in the local environment 100 and remote resources, such as remote servers 110 or other users. The quality of service (QoS) requirements for traffic traversing the internet 120 may inform the policies used by the access point 150. For instance, latency-sensitive traffic destined for a remote service via the internet 120 may be prioritized and placed in an enhanced TUA group for reliable uplink scheduling based on stream classification service (SCS) quality of service characteristics (QC) signaling.

The environment 100 may also include wired client devices, such as desktop computers 130. These desktop computers 130 may also access resources on the network and communicate with wireless devices 160, 170, and 180. While these wired devices may not directly participate in the wireless triggering mechanisms, their traffic contributes to the overall network load. The access point 150 may manage wireless resources to ensure that both wired users (e.g., on computers 130) and wireless users (e.g., in TUA groups 165, 185) receive their required quality of service.

A data center 140 may represent a local or edge computing resource available in the environment 100. The data center 140 may host latency-critical applications that interact frequently with wireless devices, such as industrial internet of things (IIOT) programmable logic controllers (PLCs). Traffic to and from the data center 140 may have very short service intervals (e.g., 1-5 ms), making the overhead of standard triggers problematic. In such cases, an access point 150 may establish a triggered uplink access (TUA) group for devices communicating with the data center 140 and use compressed, enhanced trigger frames to improve efficiency.

The environment 100 includes an access point (AP) 150 that provides wireless connectivity to devices 160, 170, and 180. The access point 150 may comprise a processor, a network interface controller, and a memory storing coordinated triggered uplink access (C-TUA) logic. In an enhanced TUA (E-TUA) embodiment, the C-TUA logic may be configured to establish a TUA group, such as First TUA group 165 or Second TUA group 185, by identifying their similar predictable traffic, potentially based on received SCS QC signaling or learned traffic periodicity. The AP 150 may then transmit a group announcement message defining uplink parameters and subsequently transmit a single, enhanced trigger frame comprising a group identifier (GID) to command the entire group to transmit, which may omit per-wireless device user information. In a coordinated TUA (C-TUA) embodiment (e.g., in a dense multi-AP environment), the AP 150 could operate as a leader AP by exchanging C-TUA capabilities with a second, follower AP, coordinating a service period (SP) with that follower AP, and transmitting a proxy trigger frame on behalf of the follower AP to instruct wireless devices associated with that follower AP to transmit uplink data. Alternatively, in a C-TUA embodiment, the AP 150 could operate as a follower AP, providing its wireless device information (e.g., for devices 160, 170, 180) to a leader AP and activating its receiver to capture uplink data from its devices that were triggered by a proxy trigger from that leader AP.

A wireless device 160, such as a smartphone, may associate with the access point 150. The wireless device 160 may run applications, like video conferencing, that generate predictable uplink traffic with known service intervals. The access point 150 may identify this traffic and include the wireless device 160 in a First TUA group 165, along with other devices like laptop 170. In a C-TUA embodiment, the wireless device 160 may indicate C-TUA capability to its associated AP 150. This capability may allow the wireless device 160 to correctly interpret and respond to a valid proxy trigger frame transmitted by a non-associated leader AP, by transmitting its uplink data directly to its associated AP 150.

A laptop 170 is another example of a wireless device that may connect to the access point 150. The laptop 170 may be used for enterprise applications or virtual reality sessions that require low-latency, periodic uplink transmissions. As shown, the laptop 170 may be included in First TUA group 165, allowing it to be triggered efficiently by the access point 150 using an enhanced trigger frame comprising a GID. In a multi-AP context, if the laptop 170 were associated with a follower AP, its identifier (e.g., its AID or its TUA group GID) could be provided to a leader AP, which would then be responsible for transmitting the proxy trigger frame at the coordinated uplink transmission time.

A first triggered uplink access (TUA) group 165 can be established by the access point 150. This First TUA group 165 comprises a plurality of wireless devices, in this embodiment, wireless device 160 and laptop 170. The C-TUA logic of the access point 150 may have identified these devices as suitable for grouping based on shared traffic characteristics, such as a similar service interval (SI). By transmitting a single group announcement message, the access point 150 can define common uplink parameters (e.g., RU allocation, MCS) for the First TUA group 165, allowing it to be triggered efficiently with a single enhanced trigger frame.

A tablet 180 is also shown as a wireless device in communication with the access point 150. The tablet 180 may be running a separate application (e.g., an XR pose application) with different traffic characteristics than the devices in First TUA group 165. The tablet 180 may be in its own TUA group (or a group with other, non-depicted devices). This allows the access point 150 to manage different groups of devices on different schedules, transmitting enhanced triggers for First TUA group 165 and Second TUA group 185 at their respective service intervals. In a C-TUA context, the wireless device 180 could also be configured to listen for and validate proxy triggers from leader APs.

In some embodiments, a second TUA group 185 can include the tablet 180. The access point 150 may establish Second TUA group 185 because the tablet's traffic (e.g., 1-5 ms SI for XR pose) is different from the traffic of First TUA group 165 (e.g., 16.67 ms SI for video). By creating separate groups, the C-TUA logic can optimize transmissions for both, sending a compressed trigger frame with the GID for First TUA group 165 at one interval, and a separate compressed trigger frame with the GID for Second TUA group 185 at another, more frequent interval.

In some embodiments, a wearable device 190 may be present. Although depicting a smart watch in the embodiment of FIG. 1, other wearable devices, such as an extended reality (XR) headset, smart glasses, or an industrial wearable sensor can be utilized. The wearable device 190 can be in communication with other wireless devices or directly with the access point 150. Such wearable devices 190 often generate highly predictable, low-latency traffic, such as uplink pose data or sensor readings, which may have very short service intervals. This type of traffic is an ideal candidate for inclusion in an enhanced triggered uplink access (TUA) group, such as the second TUA group 185, as the overhead from standard triggers would be highly inefficient. In a multi-AP environment, the predictable traffic from the wearable device 190 would be communicated by its follower AP to a leader AP, which could then include its identifier in a coordinated proxy trigger frame to ensure timely transmission even in a dense network.

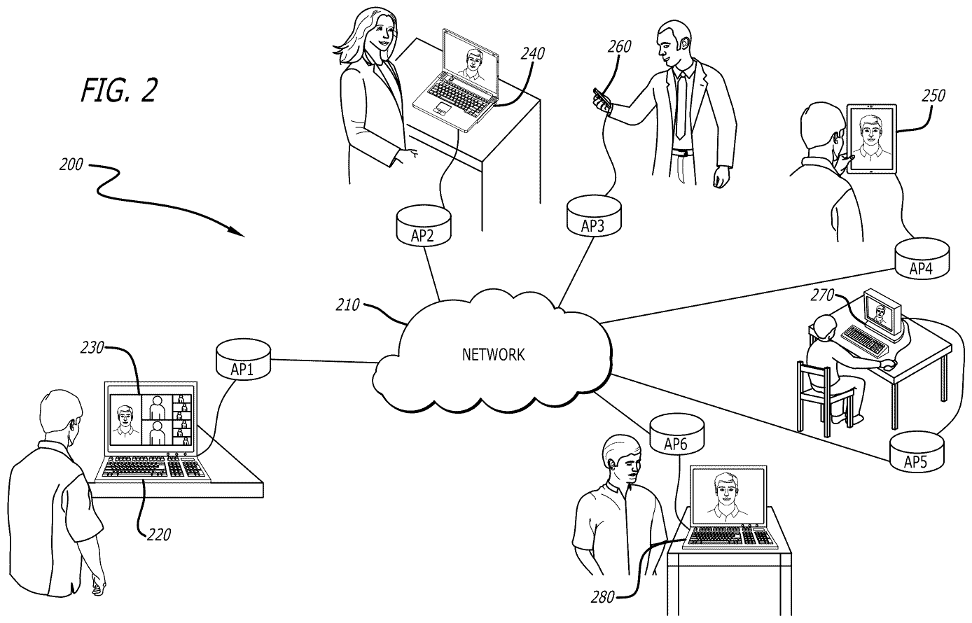

Although a specific embodiment for a single-access point network environment for carrying out the various steps, processes, methods, and operations described herein is discussed with respect to FIG. 1, any of a variety of systems and/or devices may be utilized in accordance with embodiments of the disclosure. For example, the wireless devices could include Internet of Things (IoT) sensors or actuators in addition to user devices. The elements depicted in FIG. 1 may also be interchangeable with other elements of FIGS. 2-11 as required to realize a particularly desired embodiment.

Referring to FIG. 2, an example multi-access point use case scenario, in accordance with various embodiments of the disclosure is shown. The scenario 200 may represent an enterprise environment, such as a large virtual meeting or an augmented reality classroom, where multiple participants utilize wireless devices. These wireless devices may be associated with different access points (e.g., AP1, AP2) but all participate in the same time-sensitive application, which may require predictable, low-latency uplink transmissions. This dense, multi-AP, multi-device environment illustrates the conditions under which the coordination and optimization functionalities of the coordinated triggered uplink access (C-TUA) logic may be implemented.

A network 210, such as a corporate local area network (LAN) or the internet, may facilitate communication between the various participants. The network 210 may connect the different access points (AP1, AP2, AP3, AP4, AP5, AP6) to each other and to backend services, such as a virtual meeting service server or an application server. In a coordinated triggered uplink access (C-TUA) embodiment, the access points may use the network 210 for backhaul communication to exchange C-TUA capabilities or negotiate service period (SP) sharing. The performance characteristics of the network 210 may also inform the quality of service (QoS) parameters requested by wireless devices, which can in turn be used to establish enhanced triggered uplink access (E-TUA) groups.

A first wireless device 220 may be operated by a user participating in the application, such as a virtual meeting. As depicted, wireless device 220 is associated with a first access point AP1 and may be viewing a video feed 230 from other participants. This first wireless device 220 may also generate its own periodic uplink traffic, such as its own audio and video feed, which requires reliable, scheduled access to the wireless medium. In an E-TUA embodiment, if other devices (e.g., another device associated with AP1) share similar traffic characteristics, AP1's C-TUA logic could establish a triggered uplink access (TUA) group including the first wireless device 220 and transmit an enhanced trigger frame comprising a group identifier (GID) to trigger them efficiently.

In various embodiments, application data, such as a video feed 230, can be displayed on the first wireless device 220. This data is generally received in the downlink direction, but it is often paired with a corresponding uplink stream (e.g., the user's own camera feed) that requires uplink scheduling. The characteristics of this application (e.g., 30/60 frames per second) define the service interval (SI) for the associated uplink traffic. The C-TUA logic on an access point may use this known, predictable SI, or explicit stream classification service quality of service characteristics (SCS QC) signaling, to establish a TUA group and define its uplink parameters.

A second wireless device 240, operated by another user, may be associated with a different, second access point AP2. Both the second wireless device 240 and the first wireless device 220 are participants in the same application, but their traffic is managed by separate APs (AP2 and AP1, respectively). In a dense environment where AP1 and AP2 are neighboring co-channel APs, this creates the inefficiency problem that C-TUA solves; without coordination, AP1 and AP2 might attempt to trigger their devices simultaneously, causing collisions, or must transmit sequentially, increasing latency. In a C-TUA embodiment, AP1 could act as a leader AP and transmit a proxy trigger frame on behalf of AP2 (the follower AP) to instruct the second wireless device 240 to transmit its uplink data directly to AP2, all within a coordinated service period.

A third wireless device 250 may be associated with a fourth access point AP4. This third wireless device 250 may represent a different type of participant, perhaps with a different traffic profile, such as a high-resolution telepresence unit. The fourth access point AP4 would need to exchange its C-TUA capabilities with other APs in its coordination group to participate in the C-TUA system. For example, AP4 would provide information identifying the third wireless device 250 to a leader AP, allowing the leader to transmit a proxy trigger frame at the coordinated uplink transmission time associated with AP4's service period.

A fourth wireless device 260, associated with a third access point AP3, represents another participant in the application. The uplink transmissions from the fourth wireless device 260 may be for an extended reality (XR) or industrial internet of things (IIOT) use case, which can have very short service intervals. For this type of traffic, AP3's C-TUA logic might establish a TUA group and transmit a compressed enhanced trigger frame to reduce overhead. Furthermore, AP3 could act as a follower AP, providing the GID for this TUA group to a leader AP, which would then transmit a proxy trigger frame containing that GID to trigger the entire group at once.

A fifth wireless device 270, associated with a fifth access point AP5, is also a participant in the shared application. This fifth wireless device 270 must be configured to support the C-TUA scheme, including the ability to receive and act upon proxy triggers from non-associated APs. The associated AP (AP5) may provide the fifth wireless device 270 with information about the multi-AP coordination (MAPC) group, such as a list of authorized leader AP BSSIDs or a shared MAPC coordination group (CG) address. The fifth wireless device 270 would then analyze incoming trigger frames and determine a trigger is valid if it originates from an authorized leader AP and contains its identifier, after which it would transmit its uplink data directly to its associated AP (AP5).

A sixth wireless device 280, associated with a sixth access point AP6, represents yet another participant. The scenario 200 depicts multiple follower APs (AP1-AP6), any of which could coordinate with a designated leader AP (which could be one of AP1-AP6 or another device). A leader AP could use advanced techniques like coordinated spatial reuse (C-SR) to transmit a proxy trigger frame simultaneously to the sixth wireless device 280 (associated with AP6) and the fifth wireless device 270 (associated with AP5) if their scheduling and spatial separation permit. This allows for even greater spatial efficiency in dense, multi-AP deployments like the one shown in this figure.

A first access point AP1 provides wireless connectivity for the first wireless device 220. The first access point AP1 may comprise a processor and memory storing C-TUA logic. In a C-TUA embodiment, the first access point AP1 may operate as a leader AP, coordinating transmissions for other APs, or as a follower AP, providing its device information (e.g., for device 220) to a leader. In an E-TUA embodiment, the first access point AP1's C-TUA logic may establish a TUA group for the first wireless device 220 and transmit enhanced trigger frames.

A second access point AP2 provides connectivity for the second wireless device 240. As a neighbor to the first access point AP1 in a dense deployment, the second access point AP2 may be a member of the same MAPC group. The second access point AP2 may act as a follower AP, exchanging its C-TUA capabilities and negotiating an SP with a leader AP. The leader AP would then transmit a proxy trigger frame on behalf of the second access point AP2 to trigger the second wireless device 240, which would then transmit its uplink data directly to the second access point AP2.

A third access point AP3 provides connectivity for the fourth wireless device 260. The third access point AP3's C-TUA logic may establish an E-TUA group for the fourth wireless device 260, which may have latency-sensitive traffic. In a C-TUA embodiment, the third access point AP3 may act as a follower AP and provide the GID for this TUA group to a leader AP. The leader AP could then transmit a single proxy trigger frame containing this GID to efficiently trigger all members of the fourth wireless device 260's group.

A fourth access point AP4 provides connectivity for the third wireless device 250. The fourth access point AP4 may participate in the MAPC group by exchanging its C-TUA capabilities, indicating its support for C-TUA operations. As a follower AP, the fourth access point AP4 would provide information identifying the third wireless device 250 to a leader AP. The fourth access point AP4 would then monitor its SP schedule and activate its receiver to capture the uplink data from the third wireless device 250 after it is triggered by the leader's proxy trigger frame.

A fifth access point AP5 provides connectivity for the fifth wireless device 270. The fifth access point AP5, as a follower AP, may be responsible for informing its associated fifth wireless device 270 about the C-TUA operation. This may include providing the fifth wireless device 270 with a list of authorized BSSIDs or a shared MAPC CG address to validate incoming proxy triggers. The fifth access point AP5 would then be responsible for transmitting acknowledgements to the fifth wireless device 270 after receiving its uplink data.

A sixth access point AP6 provides connectivity for the sixth wireless device 280. The sixth access point AP6 may be a follower AP participating in an advanced C-TUA scheme, such as coordinated spatial reuse (C-SR). A leader AP could transmit a proxy trigger frame that simultaneously triggers the sixth wireless device 280 (associated with AP6) and the fifth wireless device 270 (associated with AP5). The sixth access point AP6 would exchange C-TUA capabilities indicating its support for such advanced features with the leader AP

[symbol]

In one example embodiment of coordinated triggered uplink access (C-TUA) operation within the scenario 200, access point AP1 may act as a leader AP, and access point AP2 may act as a follower AP, with both being members of a multi-AP coordination (MAPC) group. AP1 and AP2 may first exchange C-TUA capabilities and coordinate an uplink transmission time associated with a service period (SP) for the second wireless device 240. At the coordinated time, instead of AP2 transmitting its own trigger, the leader AP1 may transmit a proxy trigger frame on behalf of AP2. This proxy trigger frame may comprise an identifier corresponding to the second wireless device 240, instructing it to transmit its uplink data directly to its associated follower AP (AP2). AP2 would then activate its receiver to capture this uplink data and subsequently transmit an acknowledgement.

In another example embodiment, the enhanced TUA (E-TUA) and C-TUA systems may operate together. The third access point AP3, managing the fourth wireless device 260, may first establish a triggered uplink access (TUA) group comprising the fourth wireless device 260 and other (non-depicted) devices with similar predictable traffic, such as from an industrial or XR application. AP3 would transmit a group announcement message defining uplink parameters and assigning a group identifier (GID) to this new TUA group. Subsequently, AP3, acting as a follower AP, may coordinate an SP with a leader AP (e.g., AP1). When providing its device information, AP3 may provide the GID for its TUA group, and the APs may exchange capabilities indicating support for GID-based triggering. At the coordinated uplink transmission time, the leader AP (AP1) may then transmit a single proxy trigger frame that is also an enhanced trigger frame, comprising the GID provided by AP3. This single, compressed trigger frame instructs the entire plurality of wireless devices in AP3's group, including the fourth wireless device 260, to transmit their uplink data, which is then received directly by AP3.

The C-TUA system may also be scaled to coordinate multiple follower APs simultaneously, as depicted by the fifth access point AP5 and the sixth access point AP6. A leader AP (e.g., AP1) may coordinate an uplink transmission time with both AP5 and AP6, exchanging C-TUA capabilities that may indicate support for coordinated spatial reuse (C-SR). If the leader AP's C-TUA logic determines that their respective wireless devices (fifth wireless device 270 and sixth wireless device 280) can transmit concurrently without undue interference, it may transmit a proxy trigger frame (or frames) using C-SR. This single transmission event from the leader AP may simultaneously instruct the fifth wireless device 270 to transmit uplink data to AP5 and the sixth wireless device 280 to transmit uplink data to AP6, further improving the overall spectral efficiency of the dense environment.

Although a specific embodiment for a multi-access point use case scenario for carrying out the various steps, processes, methods, and operations described herein is discussed with respect to FIG. 2, any of a variety of systems and/or devices may be utilized in accordance with embodiments of the disclosure. For example, the network could represent a private enterprise network instead of the public internet. The elements depicted in FIG. 2 may also be interchangeable with other elements of FIGS. 1 and 3-11 as required to realize a particularly desired embodiment.

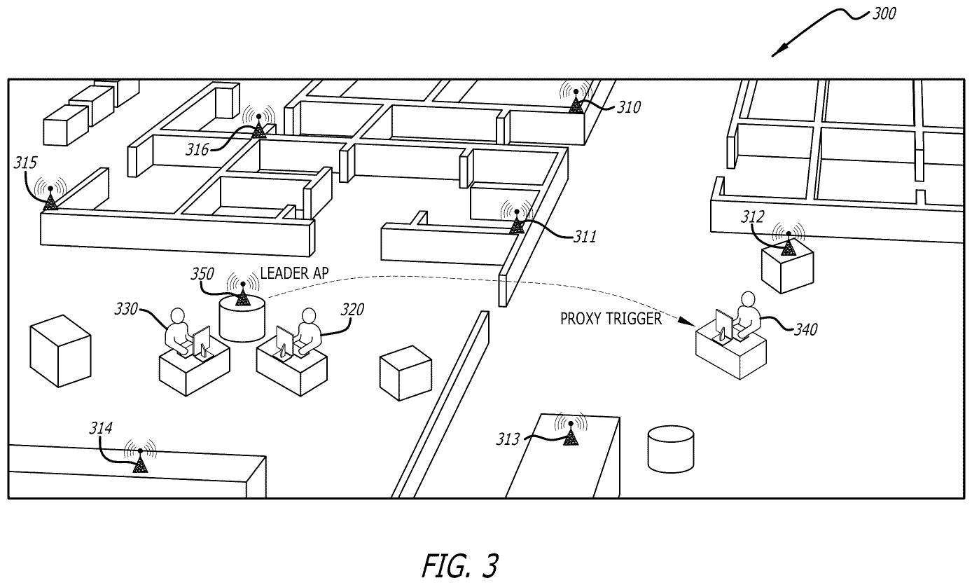

Referring to FIG. 3, an example multi-access point network environment depicting a proxy trigger transmission, in accordance with various embodiments of the disclosure is shown. The environment 300 may represent an enterprise office, factory floor, or other dense deployment containing multiple access points and wireless devices. This type of dense deployment may suffer from high overhead and latency when standard wireless coordination mechanisms are used, particularly for applications with short, predictable service intervals. The coordinated triggered uplink access (C-TUA) and enhanced triggered uplink access (E-TUA) systems described herein may be deployed in such an environment 300 to improve efficiency.

In various embodiments, a first access point 310 may be deployed within the environment 300 to provide wireless coverage to a portion of the area. The first access point 310 may participate in a multi-AP coordination (MAPC) group with neighboring APs, such as a leader access point 350. In such a group, the first access point 310 could operate as a follower AP, exchanging its C-TUA capabilities and negotiating service periods (SPs) for its associated wireless devices. In other embodiments, the first access point 310 could itself establish an enhanced TUA (E-TUA) group for its own devices, identifying them based on learned traffic periodicity and transmitting compressed, group identifier (GID) based trigger frames.

A second access point 311 represents another wireless access provider within the dense environment 300. The second access point 311 may also be a member of the MAPC group, coordinating its transmissions with the leader access point 350 and other follower APs. This coordination, such as negotiating SPs, helps avoid the significant overhead of standard multi-AP coordination, which can be highly inefficient for small, frequent grants like those used in Industrial IoT (IIOT) or extended reality (XR) applications. In some embodiments, the second access point 311 may support receiving proxy triggers for its associated devices, having indicated this capability during the C-TUA capability exchange.

A third access point 312 is depicted in proximity to the leader access point 350 and a third wireless device 340. In the embodiment shown, the third access point 312 may operate as a second, follower AP, associated with the third wireless device 340. As a follower AP, the third access point 312 may have provided information identifying the third wireless device 340 (e.g., its association identifier (AID) or a TUA group GID) to the leader access point 350. When the leader access point 350 transmits the proxy trigger frame, the third wireless device 340 is instructed to transmit its uplink data directly to the third access point 312, which would then activate its receiver to capture this data and subsequently transmit an acknowledgement.

A fourth access point 313 provides further wireless coverage within the environment 300. The fourth access point 313 may also be a follower AP within the MAPC group, coordinating with the leader access point 350. In some embodiments, the leader access point 350 may be configured to transmit a proxy trigger frame simultaneously to wireless devices associated with the third access point 312 (e.g., the third wireless device 340) and wireless devices associated with the fourth access point 313 (e.g., a non-depicted device) using coordinated spatial reuse (C-SR). This would require the fourth access point 313 to have exchanged capabilities indicating support for such operation.

A fifth access point 314 is another member of the multi-AP deployment. Like other APs, the fifth access point 314 may implement the C-TUA logic. This logic may allow it to establish TUA groups based on explicit stream classification service quality of service characteristics (SCS QC) signaling received from its associated wireless devices. For example, a device running a high-QoS application may signal its predictable service interval (SI), allowing the fifth access point 314 to place it in a TUA group for efficient triggering using an enhanced trigger frame.

A sixth access point 315 provides wireless connectivity in another area of the environment 300. The sixth access point 315 may also be a member of the MAPC group established by the leader access point 350. In some embodiments, the C-TUA capabilities exchanged may indicate support for specific security mechanisms, such as control frame protection for proxy trigger frames. The sixth access point 315 would need to share a common key with the leader access point 350 and its associated wireless devices to validate the protected proxy triggers.

A seventh access point 316 is shown providing coverage in another portion of the environment 300. The seventh access point 316 may be configured to establish TUA groups and associate them with broadcast target wake time (TWT) groups. This allows the seventh access point 316 to leverage the TWT mechanism for power saving and scheduling alignment, and then use the highly efficient enhanced trigger frame (comprising a GID) at the actual wake time to trigger the group transmission.

A first wireless device 320 is depicted associated with the leader access point 350. The C-TUA logic of the leader access point 350 may identify that the first wireless device 320 and a second wireless device 330 both have similar predictable traffic. In such a scenario, the leader access point 350 may establish an enhanced TUA (E-TUA) group comprising this plurality of wireless devices and transmit a group announcement message defining their shared uplink parameters (e.g., a fixed RU allocation). Subsequently, the leader access point 350 could transmit a single enhanced trigger frame containing a GID to trigger both the first wireless device 320 and the second wireless device 330 simultaneously.

A second wireless device 330 is also shown associated with the leader access point 350. As a member of an E-TUA group with the first wireless device 320, the second wireless device 330 would be configured to monitor for trigger frames. Upon receiving an enhanced trigger frame containing its assigned TUA group identifier (GID), it would transmit its uplink data on its pre-defined resource. This enhanced trigger frame would omit per-wireless device user information, thereby significantly reducing overhead, and may also include a compressed common information field.

A third wireless device 340 is depicted in the coverage area of the third access point 312 (a follower AP). As shown, the third wireless device 340 is the target of the ‘PROXY TRIGGER’ from the leader access point 350. This third wireless device 340 must have C-TUA capabilities, including the ability to validate and respond to a trigger from a non-associated AP. To facilitate this, the third wireless device 340 may have received MAPC coordination group (CG) info from its associated third access point 312, such as a shared MAPC CG address, which the leader access point 350 uses as the transmitter address for the proxy trigger frame. Upon receiving the valid proxy trigger, the third wireless device 340 transmits its uplink data directly to its associated follower, the third access point 312.

The leader access point 350 may comprise a processor and C-TUA logic configured to coordinate the multi-AP coordination (MAPC) group. The leader access point 350 may exchange C-TUA capabilities with follower APs, such as the third access point 312, coordinate an uplink transmission time associated with the follower's service period (SP), and receive information identifying the follower's third wireless device 340. At the coordinated time, the leader access point 350 transmits the proxy trigger frame on behalf of the follower third access point 312, instructing the third wireless device 340 to transmit. This C-TUA proxy mechanism avoids the significant overhead (e.g., 4-5 control frames) of standard 802.11bn coordination, which is highly inefficient for small, frequent (e.g., 1-5 ms SI) transmissions.

In one example operational embodiment within the environment 300, the leader access point 350 may coordinate with both the third access point 312 and the fourth access point 313. The third access point 312 may have the third wireless device 340 needing a 5 ms SP, and the fourth access point 313 may have another device (not shown) needing a similar SP shortly after. The leader access point 350 may negotiate back-to-back SPs, first transmitting a proxy trigger frame to the third wireless device 340, and then, moments later, transmitting a second proxy trigger frame to the device associated with the fourth access point 313. This centralized triggering by the leader access point 350 avoids channel contention between the third access point 312 and the fourth access point 313 and eliminates the high overhead of standard AP-to-AP handoffs.

In another example embodiment, the enhanced and coordinated systems may be combined for maximum efficiency. For instance, the second access point 311 (as a follower AP) might establish an E-TUA group for several industrial sensors in its area, assigning them a TUA group identifier (GID). The second access point 311 would then provide this GID to the leader access point 350 as the “information identifying at least one wireless device”. The APs may also exchange capabilities indicating support for GID-based triggering. At the coordinated uplink transmission time, the leader access point 350 would transmit a single proxy trigger frame, which is also an enhanced trigger frame, containing the GID from the second access point 311. This single, compressed proxy trigger frame instructs all sensors in the group to transmit their uplink data directly to the second access point 311.

The leader access point 350 may simultaneously manage its own associated devices. While coordinating proxy triggers for follower APs, such as the third access point 312 and the fourth access point 313, the leader access point 350 may also manage an E-TUA group for its own associated devices, the first wireless device 320 and the second wireless device 330. The C-TUA logic on the leader access point 350 may schedule its own group's enhanced trigger transmission in a separate, non-overlapping SP. This allows the leader access point 350 to act as both a C-TUA coordinator for the entire MAPC group and an E-TUA-enabled AP for its own clients, optimizing efficiency at both the inter-AP and intra-AP levels.

Although a specific embodiment for a multi-access point network environment depicting a proxy trigger transmission for carrying out the various steps, processes, methods, and operations described herein is discussed with respect to FIG. 3, any of a variety of systems and/or devices may be utilized in accordance with embodiments of the disclosure. For example, the leader access point and follower access point could be part of a mesh network configuration. The elements depicted in FIG. 3 may also be interchangeable with other elements of FIGS. 1-2 and 4-11 as required to realize a particularly desired embodiment.

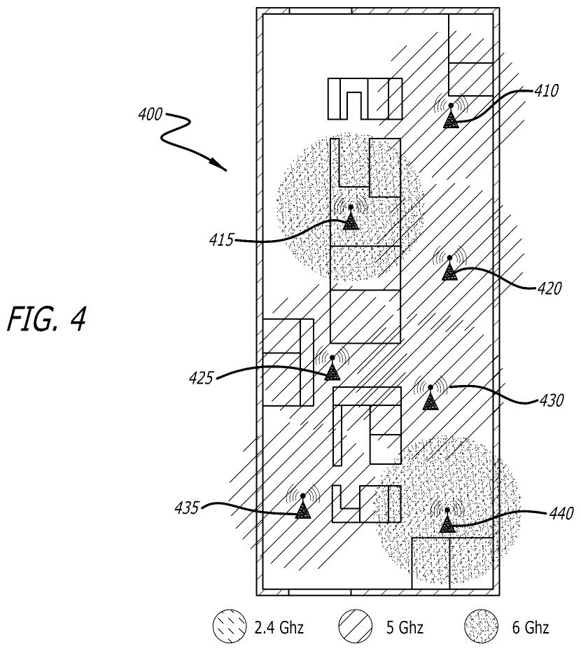

Referring to FIG. 4, an example of overlapping coverage areas in a multi-access point environment, in accordance with various embodiments of the disclosure is shown. The environment 400 may represent an enterprise office, factory floor, or other dense deployment where multiple access points are installed in close proximity to provide comprehensive wireless coverage. As depicted by the various patterns, which may represent different frequency bands such as 2.4 Ghz, 5 Ghz, or 6 Ghz, the coverage areas of these access points often overlap significantly. This overlap can create co-channel interference and channel contention, which may degrade network performance, especially for latency-sensitive applications that rely on triggered uplink access. The environment 400 illustrates the conditions under which a coordinated triggered uplink access (C-TUA) system may be implemented to manage transmissions between the multiple access points and improve overall efficiency.

A first access point 410 may be deployed in the environment 400, providing wireless coverage as indicated by its hatched pattern. As shown, its coverage area may overlap with that of a second access point 415 and a fourth access point 430. This first access point 410 may be a member of a multi-AP coordination (MAPC) group and could, in various embodiments, operate as a leader AP, coordinating transmissions for its neighbors. In other embodiments, the first access point 410 could operate as a follower AP, exchanging its C-TUA capabilities with a leader and providing its wireless device information for proxy triggering. The C-TUA logic on the first access point 410 may also be configured to establish and manage enhanced TUA (E-TUA) groups for its own associated wireless devices.

A second access point 415 is deployed in the environment 400, potentially operating on a different frequency band, such as 2.4 Ghz as suggested by its stippled pattern. Its coverage area may overlap with the first access point 410 and a third access point 420, creating potential interference that can be mitigated by C-TUA. In a C-TUA embodiment, the second access point 415 could act as a follower AP, negotiating a service period (SP) with a leader AP. The second access point 415 would provide its wireless device information (e.g., AIDs or GIDs) to the leader, which would then transmit a proxy trigger frame at the coordinated uplink transmission time.

A third access point 420 provides wireless connectivity, and its coverage area may overlap with the second access point 415 and a fifth access point 425. The coordinated triggered uplink access (C-TUA) logic on the third access point 420 may be configured to establish a triggered uplink access (TUA) group for a plurality of wireless devices associated with it. This establishment may be based on identifying predictable traffic from explicit stream classification service quality of service characteristics (SCS QC) signaling or from learned traffic periodicity. The third access point 420 could then transmit an enhanced trigger frame, comprising a group identifier (GID), to trigger these devices efficiently while omitting per-wireless device user information.

A fourth access point 430 is located in a particularly dense area of the environment 400, with its coverage overlapping several other APs, including the first access point 410, the fifth access point 425, and a sixth access point 435. This high potential for co-channel interference makes it a prime candidate for C-TUA coordination. A leader AP coordinating this area might use advanced techniques like coordinated spatial reuse (C-SR). This would allow the leader to transmit proxy triggers simultaneously to a wireless device associated with the fourth access point 430 and another device associated with the sixth access point 435, maximizing spatial efficiency.

A fifth access point 425 provides coverage that may overlap with the third access point 420 and the fourth access point 430. As a member of a MAPC group, the fifth access point 425 would exchange its C-TUA capabilities with its neighbors. This exchange may indicate its support for receiving proxy trigger frames from a leader AP. It might also indicate support for specific triggering methods, such as via shared association identifiers (AIDs) or TUA group identifiers (GIDs), or support for control frame protection.

A sixth access point 435 is also deployed in the dense environment 400, with coverage overlapping the fifth access point 425 and the fourth access point 430. The C-TUA logic on the sixth access point 435 may establish an E-TUA group for its associated wireless devices. When establishing this group, the logic may select a group identifier (GID) from the available association identifier (AID) space that it manages. This GID would then be included in a group announcement message and used in subsequent enhanced trigger frames to efficiently trigger the entire group.

A seventh access point 440 provides coverage at one end of the environment 400, overlapping with the fourth access point 430. The C-TUA logic on the seventh access point 440 may be configured to associate an established TUA group with a broadcast target wake time (TWT) group. This allows the wireless devices in the TUA group to utilize TWT for power-saving, aligning their wake times. The seventh access point 440 can then transmit the enhanced trigger frame at the coordinated wake time to ensure efficient uplink transmission.

In an example operational embodiment within the environment 400, the first access point 410 may operate as a leader AP for a MAPC group that includes the second access point 415 and the fourth access point 430 as follower APs. Due to the significant overlap, the first access point 410 may coordinate SPs for its followers. The first access point 410 may receive information from the second access point 415 identifying a first wireless device (not shown) and coordinate a first uplink transmission time. At that time, it transmits a proxy trigger frame for that device. Subsequently, it may transmit a second proxy trigger frame for a different wireless device associated with the fourth access point 430, preventing both follower APs from contending for the channel and improving overall latency.

The coordinated and enhanced systems may operate synergistically within the environment 400. For example, the third access point 420 may first act independently to establish an E-TUA group for several wireless devices in its coverage area, assigning them a TUA GID. The third access point 420, acting as a follower AP, may then provide this single GID to the first access point 410 (acting as leader AP) as its “information identifying at least one wireless device”. The leader AP (first access point 410) can then transmit a single proxy trigger frame containing this GID, which is also an enhanced trigger frame, to efficiently trigger all members of the follower's group at once.

To ensure trigger frames are correctly received and validated in the dense environment 400, a shared MAPC coordination group (CG) address may be used. A wireless device (not shown) associated with the fourth access point 430 (a follower) may be configured by it to listen for triggers from both its own AP and this shared CG address. The first access point 410 (the leader) would then transmit its proxy trigger frame using this MAPC CG address as the transmitter address. This allows the wireless device to accept the proxy trigger as valid, even though it originates from a non-associated AP, preventing it from ignoring a valid C-TUA command

[symbol]

Although a specific embodiment for overlapping coverage areas in a multi-access point environment for carrying out the various steps, processes, methods, and operations described herein is discussed with respect to FIG. 4, any of a variety of systems and/or devices may be utilized in accordance with embodiments of the disclosure. For example, the different coverage areas could represent different security domains within the same physical space. The elements depicted in FIG. 4 may also be interchangeable with other elements of FIGS. 1-3 and 5-11 as required to realize a particularly desired embodiment.

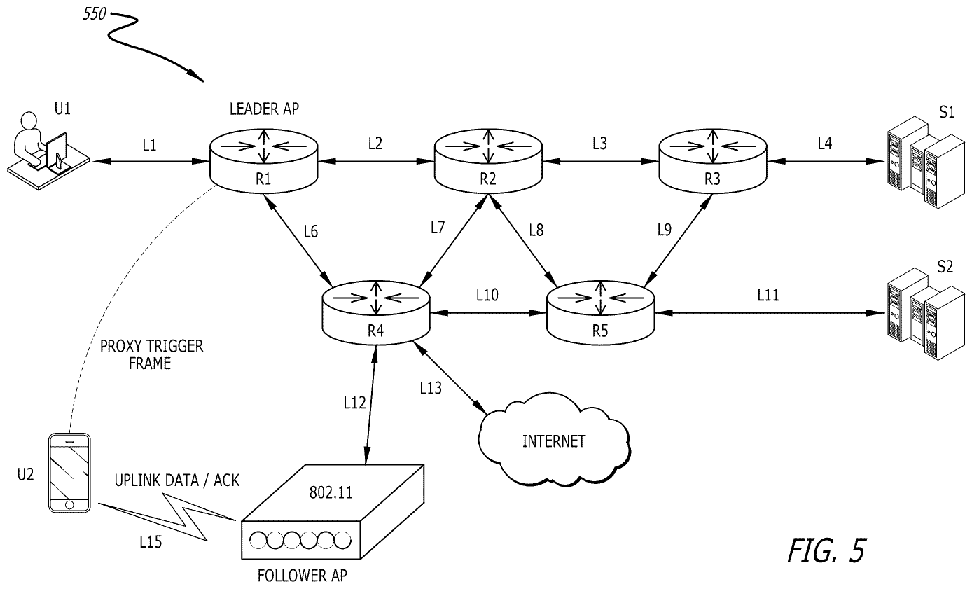

Referring to FIG. 5, a system diagram for coordinated triggered uplink access operation, in accordance with various embodiments of the disclosure is shown. The system 550 depicts a network comprising both wired and wireless components, illustrating the data flow and coordination for the coordinated triggered uplink access (C-TUA) mechanism. A leader access point R1 may transmit a proxy trigger frame to a wireless device U2, which is associated with a follower access point W2. The wireless device U2 may then transmit its uplink data directly to the follower access point W2.

A user U1 may operate a wired device that communicates with a first server S1 via a first communication link L1, a leader access point R1, a second communication link L2, a first router R2, a third communication link L3, a second router R3, and a fourth communication link L4. This traffic may be part of a high-priority enterprise application. The leader access point R1, in addition to managing its C-TUA leader responsibilities, may also manage its own traffic and associated devices, such as by prioritizing traffic from the user U1.

A first server S1 may represent a local or remote application server, such as a video conferencing host or an industrial control server. The first server S1 may be the destination for uplink data originating from both wired users like the user U1 and wireless users like a wireless device U2. The traffic characteristics required by the first server S1 (e.g., periodic updates) may be used by an access point to identify predictable traffic patterns suitable for triggered uplink access (TUA) group establishment.

A second server S2 may represent another network resource, receiving data from a fourth router R5 via a fifth communication link L11. This second server S2 may host a different application or service than the first server S1. The network routing logic may direct traffic to either the first server S1 or the second server S2 based on network policies, load, or application type, and the C-TUA and enhanced TUA (E-TUA) mechanisms may ensure that uplink data destined for either server is scheduled efficiently.

The system 150 includes a leader access point R1, which may be an access point comprising a processor and C-TUA logic. In its role as a leader, the leader access point R1 may establish a multi-AP coordination (MAPC) group with the follower access point W2 and exchange C-TUA capabilities with it. The leader access point R1 may then coordinate an uplink transmission time with the follower access point W2, based on its service period (SP), and receive information identifying the wireless device U2 as needing a trigger. As depicted, the leader access point R1 may transmit the proxy trigger frame on behalf of the follower access point W2 to instruct the wireless device U2 to transmit its uplink data. In some embodiments, the leader access point R1 may also establish its own E-TUA groups for wired or wireless devices associated directly with it (like user U1, if it were wireless), using enhanced trigger frames with group identifiers (GIDs) to optimize its own cell's efficiency.

A first router R2, a second router R3, a third router R4, and a fourth router R5 represent network routing devices that forward packets through the network 150. These routers (R2, R3, R4, R5) may connect the various access points, servers, and the internet. For example, the leader access point R1 may be in communication with the third router R4 and the fourth router R5 via a sixth communication link L6 and a seventh communication link L7 (from R2), and an eighth communication link L8 (from R2) and a ninth communication link L9 (from R3) respectively. The third router R4 and the fourth router R5 may communicate via a tenth communication link L10. While these routers may not participate directly in the 802.11 C-TUA triggering, their proper operation ensures that uplink data, once received by the follower access point W2 and forwarded, reaches its intended destination, such as the first server S1 or the second server S2.

A follower access point W2 may be an access point also comprising C-TUA logic. The follower access point W2 may be a member of the MAPC group and may exchange its capabilities with the leader access point R1, indicating its support for C-TUA operation or for receiving proxy triggers. The follower access point W2 may provide information (e.g., AID or GID) identifying the wireless device U2 to the leader access point R1 and negotiate an SP. Crucially, the follower access point W2 is the device that receives the uplink data directly from its associated wireless device U2, as indicated by a communication link L15, and is responsible for transmitting any subsequent acknowledgements. This mechanism avoids the latency and overhead of the follower access point W2 having to obtain a separate transmission opportunity just to send its own trigger.

A wireless device U2, such as a mobile phone or industrial sensor, may be associated with the follower access point W2. The wireless device U2 may be configured to support C-TUA, allowing it to receive and validate a proxy trigger frame from the non-associated leader access point R1. This validation may be based on the proxy trigger frame using a shared MAPC coordination group (CG) address as its transmitter address. Upon receiving the valid proxy trigger frame, which comprises an identifier corresponding to the wireless device U2, the wireless device U2 is instructed to transmit its uplink data directly to its associated follower access point W2 via the communication link L15.

The system 150 includes various communication links, such as L1, L2, L3, L4, L6, L7, L8, L9, L10, L11, L12, and L13. These links represent the logical or physical connections between the network components, such as Ethernet, fiber, or wireless backhaul. A twelfth communication link L12 and a thirteenth communication link L13 may connect the third router R4 to the follower access point W2 and the internet, respectively. A communication link L15, labeled as “UPLINK DATA/ACK,” represents the 802.11 wireless medium connection between the wireless device U2 and the follower access point W2, used for the data transmission triggered by the leader AP and the subsequent acknowledgement from the follower AP.

The internet may be connected to the third router R4 via the thirteenth communication link L13. This provides connectivity for devices in the system 150 to external resources. Uplink data received by the follower access point W2 from the wireless device U2 may be forwarded through the third router R4 and onto the internet, for example, to reach a cloud-based application server. The proxy trigger frame is depicted as a dashed arrow from the leader access point R1 to the wireless device U2. This represents the control frame transmitted by the leader access point R1 on behalf of the follower access point W2. This proxy trigger frame is the core of the C-TUA mechanism, as it eliminates the need for the follower access point W2 to contend for the medium to send its own trigger, thus saving significant overhead. In some embodiments, this proxy trigger frame may itself be an enhanced trigger frame, comprising a GID to trigger a TUA group associated with the follower access point W2.

In a comprehensive example embodiment, the wireless device U2 may be part of an E-TUA group established by its associated follower access point W2, perhaps because it is running a predictable XR application. The follower access point W2 may establish this group based on received SCS QC signaling and announce parameters like a fixed RU allocation and a GID. The follower access point W2, participating in a C-TUA MAPC group with the leader access point R1, may then provide this GID as the information identifying at least one wireless device. At the coordinated uplink transmission time, the leader access point R1 may transmit a proxy trigger frame that is also an enhanced trigger frame, comprising this GID and omitting per-wireless device user information. The wireless device U2 (and other members of its group, not shown) would validate this trigger (e.g., using a MAPC CG address) and transmit its uplink data on its pre-defined RU directly to the follower access point W2.

Although a specific embodiment for a system diagram for coordinated triggered uplink access operation for carrying out the various steps, processes, methods, and operations described herein is discussed with respect to FIG. 5, any of a variety of systems and/or devices may be utilized in accordance with embodiments of the disclosure. For example, the communication between the leader access point R1 and the follower access point could occur over a wired backhaul connection instead of implicitly through the network. The elements depicted in FIG. 5 may also be interchangeable with other elements of FIGS. 1-4 and 6-11 as required to realize a particularly desired embodiment.

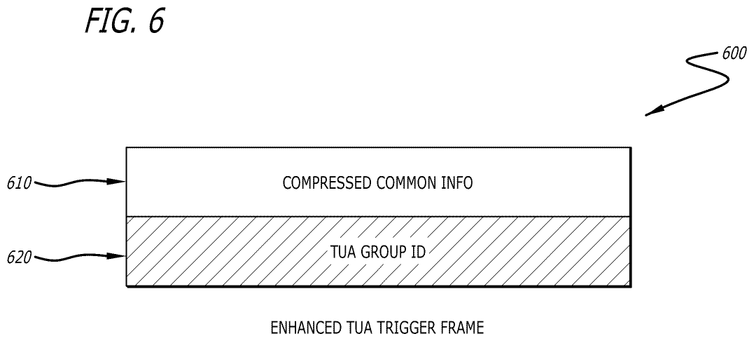

Referring to FIG. 6, a block diagram of an enhanced triggered uplink access trigger frame, in accordance with various embodiments of the disclosure is shown. The enhanced triggered uplink access (TUA) trigger frame 600 may represent a compressed control frame transmitted by an access point (AP) to trigger a plurality of wireless devices belonging to an established TUA group. A primary function of the enhanced TUA trigger frame 600 is to reduce overhead by omitting per-wireless device user information, which is particularly inefficient for applications with short, predictable service intervals. In a multi-AP coordination (MAPC) embodiment, this enhanced TUA trigger frame 600 may also function as a proxy trigger frame. For example, a leader AP may transmit the enhanced TUA trigger frame 600, comprising a group identifier (GID) provided by a follower AP, to trigger a TUA group associated with that follower AP.

The enhanced TUA trigger frame 600 may comprise a compressed common info 610. This may contain parameters that are common to all members of the TUA group being triggered. In some embodiments, the compressed common info 610 may include a specific ‘Trigger Type’ value, such as ‘Group Trigger’, to indicate that the frame is an enhanced trigger frame and should be interpreted by wireless devices as a group-based command. By pre-announcing many common parameters in a group announcement message, the information required in the compressed common info 610 at the time of triggering can be significantly reduced, further contributing to the frame's efficiency.

The enhanced TUA trigger frame 600 may also comprise a TUA group ID 620 which may contain a group identifier (GID) that corresponds to the TUA group being triggered. The TUA group ID 620 serves as a replacement for the plurality of individual per-wireless device user information fields found in standard TUA triggers, and its inclusion allows the frame to omit that per-device information. In certain embodiments, the GID contained in the TUA group ID 620 may be an identifier selected from an association identifier (AID) space utilized by the access point that established the group. In a C-TUA embodiment, the GID may be an identifier that was provided by a follower AP to the leader AP, allowing the leader's proxy trigger frame to efficiently trigger the follower's TUA group.

In an example of enhanced TUA (E-TUA) operation, an access point (e.g., AP 150 in FIG. 1) may establish a TUA group (e.g., TUA group 165) for a plurality of wireless devices (e.g., 160, 170) based on their predictable video traffic. After transmitting a group announcement message defining parameters, the AP, at the coordinated service interval (SI), may transmit the enhanced TUA trigger frame 600. This frame 600 would include the compressed common info 610 and the TUA group ID 620 assigned to that group. The wireless devices 160 and 170, upon receiving and validating this GID, would then transmit their uplink video data on their pre-allocated resources.

In a more advanced coordinated TUA (C-TUA) embodiment, the enhanced TUA trigger frame 600 may be used as the proxy trigger frame (e.g., as shown in FIG. 5). A follower AP (e.g., follower access point W2) may first establish its own TUA group for its wireless device U2 and provide the corresponding GID to a leader AP (e.g., leader access point R1) during SP negotiation. At the coordinated uplink transmission time, the leader access point R1 may transmit the enhanced TUA trigger frame 600, which contains the compressed common info 610 and the TUA group ID 620 for the follower's group. This single, compressed frame 600, transmitted by the leader AP, efficiently triggers the follower's wireless device U2 to send its data directly to the follower access point W2.

Although a specific embodiment for a block diagram of an enhanced triggered uplink access trigger frame for carrying out the various steps, processes, methods, and operations described herein is discussed with respect to FIG. 6, any of a variety of systems and/or devices may be utilized in accordance with embodiments of the disclosure. For example, the TUA Group ID 620 could be assigned dynamically based on current network conditions rather than being statically pre-assigned. The elements depicted in FIG. 6 may also be interchangeable with other elements of FIGS. 1-5 and 7-11 as required to realize a particularly desired embodiment.

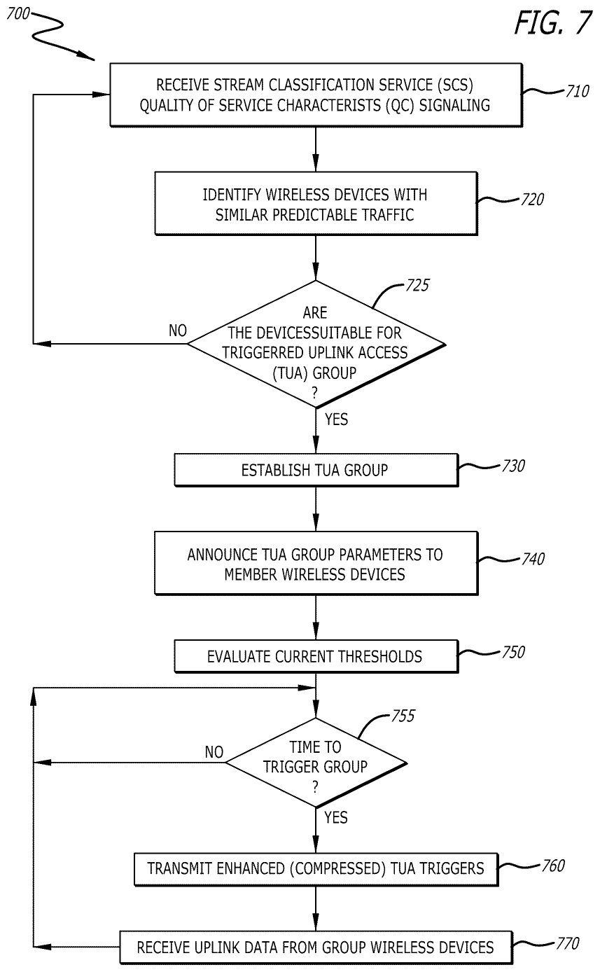

Referring to FIG. 7, a flowchart showing a process 700 for access point operation of enhanced triggered uplink access groups, in accordance with various embodiments of the disclosure is shown. In many embodiments, the process 700 can receive stream classification service (SCS) quality of service characteristics (QC) signaling (block 710). This signaling may originate from wireless devices seeking to establish communication flows with specific performance requirements. In some embodiments, the access point may actively solicit this information using specific management frames. Alternatively, the access point may passively monitor network traffic to infer traffic characteristics without explicit SCS QC signaling, allowing for opportunistic group formation.

In a number of embodiments, the process 700 can identify wireless devices with similar predictable traffic (block 720). This identification may be based on analyzing the received SCS QC parameters, looking for matching service intervals (SIs), data rates, or application types. For example, multiple wireless devices running the same extended reality (XR) application or industrial internet of things (IIOT) process might exhibit highly correlated traffic patterns suitable for grouping. In certain embodiments, the access point might maintain a database of known application profiles to aid in identifying groupable devices based on packet inspection or flow analysis.

In more embodiments, the process 700 can determine if the devices are suitable for a triggered uplink access (TUA) group (block 725). This determination may involve checking if the number of identified devices falls within a supported range (e.g., 4-8 devices per group) and if their predicted traffic schedules allow for alignment within a single trigger event. If the devices are not deemed suitable (e.g., traffic patterns are too diverse, SIs do not align, or too few/many devices are identified), then the process 700 can once again monitor traffic/receive SCS QC signaling (block 710).

However, if the devices are determined to be suitable, then the process 700 can establish a TUA group (block 730). Establishing the group may involve the access point allocating a unique group identifier (GID) for the collection of wireless devices. In some embodiments, this GID can be selected from the available association identifier (AID) space managed by the access point. Furthermore, establishing the group may include pre-determining specific uplink parameters that will apply to all members, such as a fixed resource unit (RU) allocation or a default modulation and coding scheme (MCS) intended to ensure reliable communication for the majority of transmissions.

In further embodiments, the process 700 can announce TUA group parameters to member wireless devices (block 740). This announcement ensures that all wireless devices within the group are aware of the assigned GID and the rules for responding when triggered using that GID. The announcement could be sent via dedicated management frames to each member device. Alternatively, the group information might be broadcast or multicast to the relevant devices, potentially leveraging existing mechanisms like target wake time (TWT) group management protocols.

In additional embodiments, the process 700 can evaluate current thresholds (block 750). These thresholds might relate to factors like current channel congestion, interference levels, or the specific quality of service requirements of the TUA group compared to other traffic. For instance, the access point might prioritize triggering a high-priority TUA group even under moderate congestion if the application demands low latency. In certain embodiments, these thresholds could be dynamically adjusted based on overall network load or administrative policies.

In still more embodiments, the process 700 can determine if it is time to trigger the group (block 755). This decision is typically based on the pre-determined service interval (SI) associated with the TUA group established earlier. The access point's scheduler tracks the SI timing for each active TUA group. If it is not yet time to trigger the group based on its SI, then the process 700 can continue evaluating current thresholds (block 750) or wait.

However, if it is determined that it is time to trigger the group, then the process 700 can transmit enhanced (compressed) TUA triggers (block 760). This involves sending a specially formatted trigger frame that contains the TUA group's GID instead of individual user information fields for each member device. In some embodiments, the trigger frame may also contain compressed common information relevant to the group transmission. This compressed format significantly reduces the overhead associated with triggering multiple devices simultaneously, especially for applications with short SIs.

In yet further embodiments, the process 700 can receive uplink data from group wireless devices (block 770). Following the reception of the enhanced trigger frame, each member wireless device transmits its uplink data according to the parameters announced for the group (e.g., on its assigned RU, using the determined MCS). The access point receives these potentially simultaneous uplink transmissions from the group members. The process 700 may then subsequently loop back to evaluate thresholds (block 750) and determine the next time to trigger the group (block 755).

Although a specific embodiment for a process 700 for access point operation of enhanced triggered uplink access groups for carrying out the various steps, processes, methods, and operations described herein is discussed with respect to FIG. 7, any of a variety of systems and/or processes may be utilized in accordance with embodiments of the disclosure. For example, the evaluation of thresholds could involve machine learning models to predict optimal group triggering times. The elements depicted in FIG. 7 may also be interchangeable with other elements of FIGS. 1-6 and 8-11 as required to realize a particularly desired embodiment.

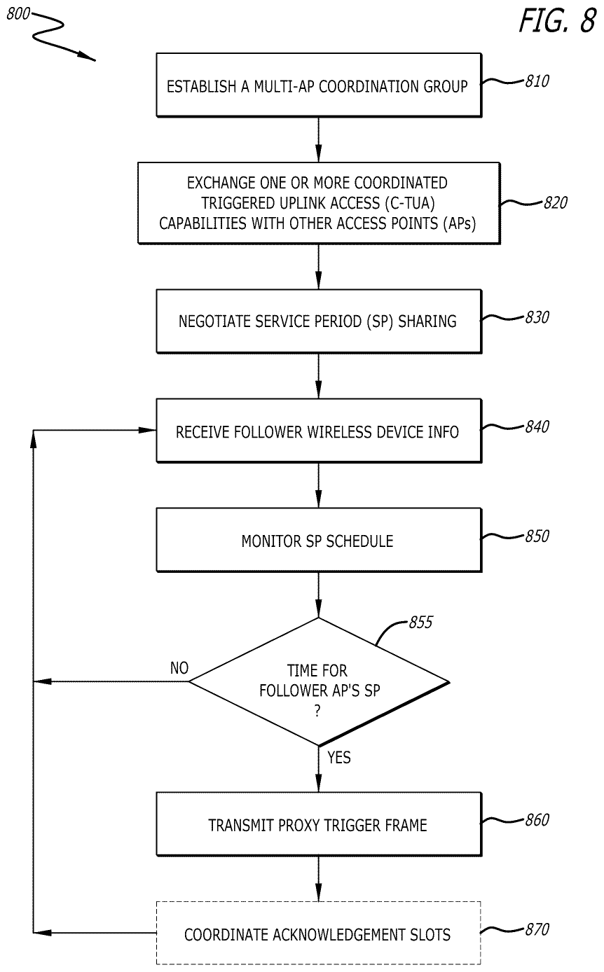

Referring to FIG. 8, a flowchart showing a process 800 for a leader access point performing coordinated triggered uplink access, in accordance with various embodiments of the disclosure is shown. In many embodiments, the process 800 can establish a multi-AP coordination group (block 810). This establishment may occur automatically upon deployment or through configuration by a network administrator. For example, the coordination group may encompass all access points (APs) within an extended service set (ESS) or may be a smaller, dynamically formed coordination group (CG) scope based on neighboring APs that detect each other. It is contemplated that the group formation could also be based on shared security credentials or administrative domains.

In a number of embodiments, the process 800 can exchange one or more coordinated triggered uplink access (C-TUA) capabilities with other access points (APs) (block 820). This exchange allows APs within the coordination group to determine which neighbors support the C-TUA protocol and specific features thereof. For instance, capabilities exchanged may indicate general support for C-TUA operation, the ability to receive proxy triggers, support for specific triggering methods like using shared association identifiers (AIDs) or group identifiers (GIDs), or support for control frame protection within the C-TUA context. In various embodiments, this capability exchange could occur during the initial MAPC group setup or periodically refreshed.

In more embodiments, the process 800 can negotiate service period (SP) sharing (block 830). This negotiation involves coordinating transmission schedules between the leader AP and potential follower APs to allocate specific time intervals (SPs) for uplink transmissions, often based on requirements like target traffic start times (TTST) or start time protection rules (STPR). For example, APs might negotiate non-overlapping SPs to avoid interference. Alternatively, negotiation could result in overlapping SPs where techniques like coordinated spatial reuse (C-SR) might be employed.

In further embodiments, the process 800 can receive follower wireless device info (block 840). As part of the SP negotiation or through separate messages, a follower AP may provide the leader AP with information about the wireless devices it needs triggered during its allocated SP. This information may include individual wireless device AIDs. In certain embodiments, if the follower AP has established enhanced TUA (E-TUA) groups, it might provide TUA group identifiers (GIDs) instead of, or in addition to, individual AIDs.

In additional embodiments, the process 800 can monitor the SP schedule (block 850). The leader AP maintains awareness of the negotiated schedule, tracking when the allocated SPs for various follower APs are set to begin. This monitoring ensures that proxy triggers are sent at the correct, coordinated times. For instance, the monitoring could involve checking a shared calendar or responding to synchronization signals within the MAPC group. In some embodiments, the schedule might be dynamically adjusted based on real-time network conditions.

In still more embodiments, the process 800 can determine if it is time for a follower AP's SP (block 855). Based on the monitored schedule, the leader AP checks if the current time corresponds to the beginning of a negotiated SP for a specific follower AP that supports C-TUA. If it is determined that it is not time for a follower AP's SP, then the process 800 can continue to monitor the SP schedule (block 850). However, if it is determined that it is time for a follower AP's SP, then the process 800 can transmit a proxy trigger frame (block 860).

In yet further embodiments, the process 800 can transmit a proxy trigger frame (block 860). Instead of the follower AP sending its own trigger (which involves significant coordination overhead), the leader AP transmits the trigger frame directly on behalf of the follower AP. This proxy trigger frame contains the necessary identifiers (AIDs or GIDs received in block 840) to instruct the follower AP's wireless device(s) to transmit their uplink data. In some embodiments, the proxy trigger frame may use a specific MAPC coordination group (CG) address as its transmitter address to ensure follower wireless devices accept it. It is contemplated that the proxy trigger frame itself could be an enhanced (compressed) trigger frame, utilizing a GID to reduce its own overhead. Furthermore, the leader AP might utilize coordinated spatial reuse (C-SR) to transmit proxy triggers simultaneously to wireless devices associated with multiple different follower APs.

In certain optional embodiments, the process 800 can coordinate acknowledgement slots (block 870). After the follower wireless devices transmit their uplink data (to the follower AP), acknowledgements are needed. The leader AP might coordinate time slots for the follower AP(s) to send these acknowledgements, perhaps granting specific transmission opportunities (TXOPs) for near-immediate block acknowledgements or scheduling time for delayed acknowledgements. Alternatively, acknowledgement timing might be implicitly defined by the protocol without explicit coordination from the leader in every instance. Following the transmission of the proxy trigger or coordination of acknowledgements, the process 800 may loop back to monitor the SP schedule (block 850) for the next trigger event.

Although a specific embodiment for a process 800 for a leader access point performing coordinated triggered uplink access for carrying out the various steps, processes, methods, and operations described herein is discussed with respect to FIG. 8, any of a variety of systems and/or processes may be utilized in accordance with embodiments of the disclosure. For example, the negotiation of service period (SP) sharing could be based on real-time load balancing calculations across the multi-AP coordination group. The elements depicted in FIG. 8 may also be interchangeable with other elements of FIGS. 1-7 and 9-11 as required to realize a particularly desired embodiment.

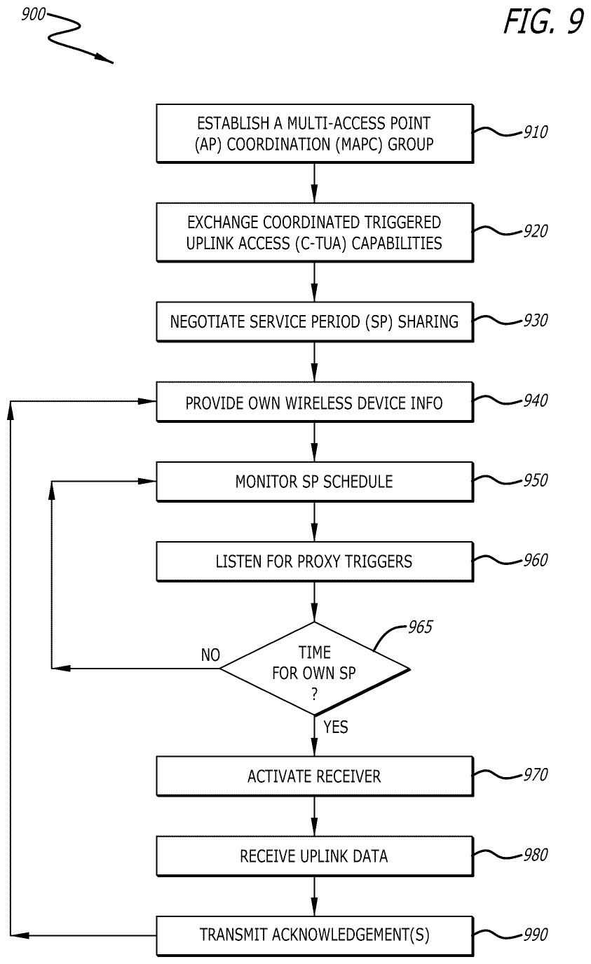

Referring to FIG. 9, a flowchart showing a process 900 for a follower access point participating in coordinated triggered uplink access, in accordance with various embodiments of the disclosure is shown. In many embodiments, the process 900 can establish a multi-access point (AP) coordination (MAPC) group (block 910). This may involve the follower AP discovering neighboring APs and engaging in a protocol exchange to join or form a coordination group intended to manage shared wireless resources. For example, this establishment could be triggered by configuration settings or dynamically based on detected network density. Alternatively, the AP might join a pre-existing MAPC group advertised by a central controller or coordinating AP.

In a number of embodiments, the process 900 can exchange coordinated triggered uplink access (C-TUA) capabilities (block 920). The follower AP communicates its ability to participate in the C-TUA scheme, informing potential leader APs of its supported features. For instance, the follower AP might indicate whether it supports receiving proxy triggers generally, whether it supports triggering via specific identifiers like shared association identifiers (AIDs) or group identifiers (GIDs), and whether it requires or supports control frame protection for proxy triggers. It is contemplated that this capability exchange could be part of the initial MAPC group setup or occur through subsequent dedicated messages.

In more embodiments, the process 900 can negotiate service period (SP) sharing (block 930). The follower AP coordinates with one or more leader APs to determine specific time intervals during which its associated wireless devices require uplink access. This negotiation might involve requesting specific SP durations based on the traffic needs of its devices (e.g., derived from Stream Classification Service Quality of Service Characteristics (SCS QC) signaling) and agreeing upon start times (e.g., Target Traffic Start Time (TTST)) with the leader(s). In some embodiments, the negotiation could result in the follower AP being allocated recurring SPs at a fixed cadence.

In further embodiments, the process 900 can provide own wireless device info (block 940). To enable the leader AP to transmit correct proxy triggers, the follower AP shares relevant information about the wireless devices that need triggering during its negotiated SPs. This information typically includes the AIDs of the individual wireless devices. For instance, if the follower AP also supports Enhanced TUA (E-TUA) grouping, it might provide a TUA Group Identifier (GID) representing multiple wireless devices instead of, or in addition to, individual AIDs.

In additional embodiments, the process 900 can monitor the SP schedule (block 950). The follower AP keeps track of the negotiated schedule to anticipate when its allocated SPs are expected to occur. This monitoring allows the follower AP to prepare its receiver circuitry at the appropriate times. In various embodiments, the schedule might be stored locally after negotiation. Alternatively, the follower AP might receive periodic updates or synchronization beacons from the leader AP or a central coordinator.

In still more embodiments, the process 900 can listen for proxy triggers (block 960). During the time leading up to and during its scheduled SP, the follower AP actively monitors the wireless medium for proxy trigger frames transmitted by the designated leader AP. This may involve configuring its receiver to accept frames transmitted using a specific MAPC coordination group (CG) address or frames originating from the known MAC address of the leader AP. It is contemplated that the follower AP might employ specific filtering mechanisms to efficiently detect relevant proxy triggers while ignoring other traffic.

In yet further embodiments, the process 900 can determine if it is time for its own SP (block 965). Based on the monitored schedule and potentially the reception of timing signals or specific trigger indicators, the follower AP determines if its negotiated service period, during which it expects a proxy trigger, has commenced. If it is determined that it is not time for its own SP, then the process 900 can continue to monitor the SP schedule (block 950) and listen for proxy triggers (block 960). However, if it is determined that it is time for its own SP, then the process 900 can activate the receiver (block 970).

In still additional embodiments, the process 900 can activate the receiver (block 970). Knowing that its wireless devices are expected to transmit uplink data shortly (in response to an anticipated proxy trigger from the leader), the follower AP prepares its receiver hardware and processing logic to capture these transmissions. This activation might involve configuring specific preamble decoders or resource unit (RU) processing based on the information provided to the leader AP (e.g., expected number of devices, potential MCS). For example, the follower AP ensures its receiver is tuned to the correct channel and bandwidth. In certain embodiments, this activation might be implicitly linked to successfully decoding a valid proxy trigger intended for its devices.

In yet more embodiments, the process 900 can receive uplink data (block 980). The follower AP captures the uplink data transmissions sent by its associated wireless devices, even though these transmissions were initiated by a proxy trigger from the leader AP. The follower AP processes these received frames as if it had sent the trigger itself, decoding the data intended for its BSS. For instance, the follower AP decodes the Physical Layer Convergence Procedure (PLCP) Protocol Data Units (PPDUs) transmitted by its wireless devices on the RUs implicitly or explicitly assigned via the proxy trigger mechanism. In some embodiments, the follower AP might also receive uplink data from wireless devices triggered by itself if the leader AP only handles proxy triggering for a subset of devices or SPs.

In numerous embodiments, the process 900 can transmit acknowledgement(s) (block 990). The follower AP is responsible for acknowledging the successful reception of uplink data from its own associated wireless devices. This acknowledgement might take the form of a block acknowledgement (BA) frame. In some embodiments, the timing for this acknowledgement might be coordinated by the leader AP, allowing for a near-immediate BA sent during a portion of the current transmission opportunity (TXOP) granted via coordinated time division multiple access (C-TDMA) by the leader. Alternatively, the follower AP might send a delayed BA in a subsequent, separately obtained TXOP. Following the transmission of acknowledgements, the process 900 may loop back to provide updated wireless device info (block 940) or directly to monitor the SP schedule (block 950) for the next cycle.

Although a specific embodiment for a process 900 for a follower access point participating in coordinated triggered uplink access for carrying out the various steps, processes, methods, and operations described herein is discussed with respect to FIG. 9, any of a variety of systems and/or processes may be utilized in accordance with embodiments of the disclosure. For example, listening for proxy triggers could involve activating specific hardware filters to reduce processing overhead. The elements depicted in FIG. 9 may also be interchangeable with other elements of FIGS. 1-8, 10, and 11 as required to realize a particularly desired embodiment.

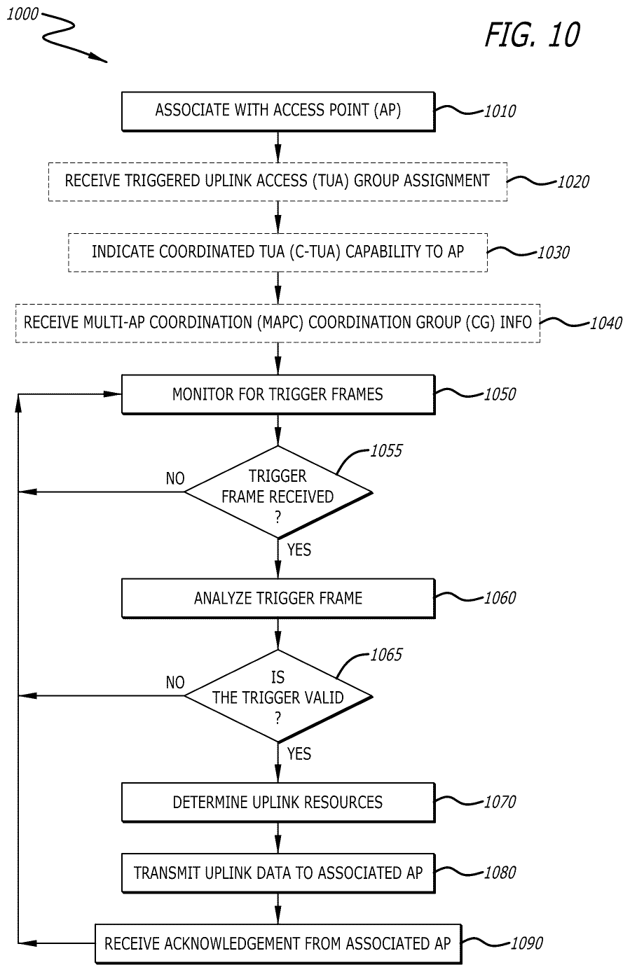

Referring to FIG. 10, a flowchart showing a process 1000 for a wireless device receiving triggered uplink access triggers, in accordance with various embodiments of the disclosure is shown. In many embodiments, the process 1000 can associate with an access point (AP) (block 1010). This association may follow standard Institute of Electrical and Electronics Engineers (IEEE) 802.11 procedures, establishing a basic service set (BSS) connection between the wireless device and the AP. For instance, the wireless device might scan for available networks and complete authentication and association handshakes with a selected AP. In certain embodiments, the association process might include negotiation of basic capabilities relevant to triggered uplink access (TUA) or quality of service (QoS).

In some optional embodiments, the process 1000 can receive a triggered uplink access (TUA) group assignment (block 1020). If the wireless device's traffic is identified by the AP as suitable for grouping (as described in FIG. 7), the AP may assign the device to a TUA group. This assignment may involve the AP sending a management frame containing the assigned group identifier (GID) and potentially pre-defined uplink parameters such as resource unit (RU) allocation or modulation and coding scheme (MCS) specific to that group. Alternatively, the group assignment could be requested by the wireless device itself, perhaps acting as a group leader, via mechanisms like the stream classification service (SCS) request/response exchange.

In additional optional embodiments, the process 1000 can indicate coordinated TUA (C-TUA) capability to the AP (block 1030). If the wireless device supports the C-TUA protocol, allowing it to receive and act upon proxy triggers from leader APs other than its associated AP, it may signal this capability during or after association. For example, this indication could be included in specific capability fields within association request frames or dedicated capability exchange messages, such as within an Ultra High Reliability (UHR) Capabilities element. In various embodiments, this capability might be mandatory for devices conforming to a future standard revision.

In further optional embodiments, the process 1000 can receive multi-AP coordination (MAPC) coordination group (CG) info (block 1040). To enable the wireless device to validate proxy triggers from non-associated APs, its associated AP may provide information about the MAPC group it belongs to. This information might include a list of basic service set identifiers (BSSIDs) corresponding to the MAC addresses of other APs authorized to send proxy triggers within the group. Alternatively, the AP could provide a single, shared MAPC CG Media Access Control (MAC) address that authorized leader APs will use as the transmitter address (TA) in proxy trigger frames.

In more embodiments, the process 1000 can monitor for trigger frames (block 1050). The wireless device actively listens on the wireless medium for trigger frames transmitted by APs. This monitoring involves tuning its receiver to the appropriate channel and attempting to decode potential trigger frame preambles. For example, the wireless device may periodically wake from a low-power state specifically to check for incoming trigger frames, especially if participating in a Target Wake Time (TWT) schedule. In certain embodiments, monitoring might involve filtering based on expected trigger frame types or source addresses.

In numerous embodiments, the process 1000 can determine if a trigger frame was received (block 1055). The wireless device evaluates whether a frame decoded during the monitoring phase is identifiable as a trigger frame. If no trigger frame is successfully received or decoded within a certain monitoring interval, then the process 1000 can continue to monitor for trigger frames (block 1050). However, if a potential trigger frame is received, then the process 1000 can analyze the trigger frame (block 1060).

In some embodiments, the process 1000 can analyze the trigger frame (block 1060). This analysis involves parsing the contents of the received trigger frame to extract key information. For example, the wireless device reads the transmitter address (TA) or BSSID field to identify the sending AP and examines the user information fields to determine if the trigger is addressed to this specific wireless device, either individually or as part of a group. In various embodiments, the analysis includes checking the trigger type field to differentiate between standard triggers, basic triggers, or enhanced group triggers.

In many further embodiments, the process 1000 can determine if the trigger is valid (block 1065). The wireless device applies rules to ascertain whether it should act upon the analyzed trigger frame. A trigger may be considered valid if it originates from the wireless device's associated AP and contains the device's own AID or an assigned TUA GID. Furthermore, if the device supports C-TUA and has received MAPC CG info, a trigger may also be considered valid if it originates from an authorized non-associated AP (matching a BSSID from the provided list or the shared MAPC CG MAC address) and contains the device's own AID or an assigned TUA GID. If the trigger frame does not meet these validity criteria (e.g., it's from an unknown AP, or it targets different devices/groups), then the process 1000 can ignore the frame and return to monitoring for trigger frames (block 1050). However, if the trigger is determined to be valid, then the process 1000 can determine uplink resources (block 1070).

In many more embodiments, the process 1000 can determine uplink resources (block 1070). Based on the valid trigger frame, the wireless device identifies the specific resources allocated for its uplink transmission. If the trigger frame is a standard or basic trigger containing per-device user information, the resources (e.g., RU, MCS, transmission duration or length) are extracted directly from those fields. However, if the trigger frame is an enhanced group trigger containing only a GID, the wireless device retrieves the pre-defined uplink resources associated with that GID from the information received during the group assignment (block 1020).

In certain embodiments, the process 1000 can transmit uplink data to the associated AP (block 1080). Using the determined uplink resources, the wireless device transmits its data packet(s). Critically, even if the trigger was a proxy trigger received from a non-associated leader AP, the uplink data transmission is always directed to the wireless device's own associated AP (the follower AP in a C-TUA scenario). For example, the destination address in the transmitted MAC frame header would be that of the associated AP.

In various embodiments, the process 1000 can receive an acknowledgement from the associated AP (block 1090). After transmitting its uplink data, the wireless device expects to receive an acknowledgement (e.g., a Block Ack) from its associated AP confirming successful reception. The timing of this acknowledgement might vary depending on whether it's immediate or delayed, potentially coordinated by the leader AP in C-TUA scenarios. Following the reception of the acknowledgement (or handling a timeout if no acknowledgement is received), the process 1000 may loop back to monitor for subsequent trigger frames (block 1050).

Although a specific embodiment for a process 1000 for a wireless device receiving triggered uplink access triggers for carrying out the various steps, processes, methods, and operations described herein is discussed with respect to FIG. 10, any of a variety of systems and/or processes may be utilized in accordance with embodiments of the disclosure. For example, the determination of uplink resources could involve the wireless device selecting from a pre-allocated set of resources announced in the group assignment. The elements depicted in FIG. 10 may also be interchangeable with other elements of FIGS. 1-9 and 11 as required to realize a particularly desired embodiment.

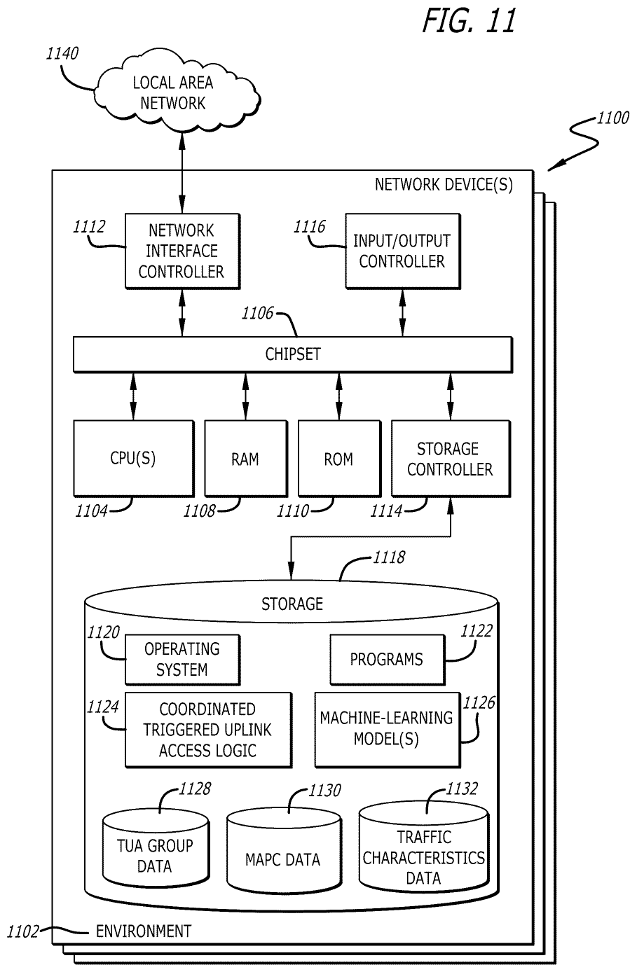

Referring to FIG. 11, a conceptual block diagram for one or more network devices 1100 capable of executing components and logic for implementing the functionality and embodiments described herein, in accordance with various embodiments of the disclosure is shown. The embodiment of the conceptual block diagram depicted in FIG. 11 can illustrate a conventional network device, personal computer, mobile game device, game server, laptop, tablet, network appliance, e-reader, smartphone, wearable device, or other computing device, and can be utilized to execute any of the application and/or logic components presented herein. The device 1100 may, in many non-limiting examples, correspond to physical devices or to virtual resources described herein.

In many embodiments, the device 1100 may include an environment 1102 such as a baseboard or “motherboard,” in physical embodiments that can be configured as a printed circuit board with a multitude of components or devices connected by way of a system bus or other electrical communication paths. Conceptually, in virtualized embodiments, the environment 1102 may be a virtual environment that encompasses and executes the remaining components and resources of the device 1100. In more embodiments, the processor(s) 1104, such as, but not limited to, central processing units (“CPUs”) can be configured to operate in conjunction with a chipset 1106. The processor(s) 1104 can be standard programmable CPUs that perform arithmetic and logical operations necessary for the operation of the device 1100.

In a number of embodiments, the processor(s) 1104 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1106 may provide an interface between the processor(s) 1104 and the remainder of the components and devices within the environment 1102. The device 1100 can incorporate different types of processors to enhance performance and efficiency across various tasks. A central processing unit (CPU) can handle primary processing tasks such as game logic, AI, and player inputs, while a graphics processing unit (GPU) can be specialized for various compute and inference tasks. Digital signal processors (DSPs) may manage audio processing, delivering high-quality sound without burdening the CPU. In portable devices, systems on a chip (SoCs) can be configured to integrate the CPU, GPU, memory, and peripherals to balance performance and efficiency. In some embodiments, application-specific integrated circuits (ASICs) can optimize specific functions like cryptographic processing, while neural processing units (NPUs) accelerate AI and machine learning tasks. Some high-end devices may also include physics processing units (PPUs) to handle complex physics calculations. However, those skilled in the art will recognize that the device 1100 can any variety or combination of processor(s) 1104 as needed to satisfy the desired application.

The chipset 1106 can provide an interface to a random-access memory (“RAM”) 1108, which can be used as the main memory in the device 1100 in some embodiments. The chipset 1106 can further be configured to provide an interface to a computer-readable storage medium such as a read-only memory (ROM 1110) or non-volatile RAM (“NVRAM”) for storing basic routines that can help with various tasks such as, but not limited to, starting up the device 1100 and/or transferring information between the various components and devices. The ROM 1110 or NVRAM can also store other application components necessary for the operation of the device 1100 in accordance with various embodiments described herein.

Additional embodiments of the device 1100 can be configured to operate in a networked environment using logical connections to remote computing devices and computer systems through a network, such as the local area network 1140. The chipset 1106 can include functionality for providing network connectivity through a network interface controller (NIC 1112), which may comprise a gigabit Ethernet adapter or similar component. The NIC 1112 can be capable of connecting the device 1100 to other devices over the local area network 1140. It is contemplated that a NIC 1112 or multiple may be present in the device 1100, connecting the device to other types of networks and remote systems, such as the Internet.

In further embodiments, the device 1100 can be connected to a storage 1118 that provides non-volatile storage for data accessible by the device 1100. The storage 1118 can, for instance, store an operating system 1120, and/or programs 1122. In various embodiments, the storage 1118 can be connected to the environment 1102 through a storage controller 1114 connected to the chipset 1106. In certain embodiments, the storage 1118 can consist of one or more physical storage units. The storage controller 1114 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

In additional embodiments, the device 1100 can store data within the storage 1118 by transforming the physical state of the physical storage units to reflect the information being stored. The specific transformation of physical state can depend on various factors. Examples of such factors can include, but are not limited to, the technology used to implement the physical storage units, whether the storage 1118 is characterized as primary or secondary storage, and the like.

In addition to the storage 1118 described above, certain embodiments of the device 1100 may also have access to other computer-readable storage media to store and retrieve information, such as program modules, data structures, or other data. It should be appreciated by those skilled in the art that computer-readable storage media is any available media that provides for the non-transitory storage of data and that can be accessed by the device 1100. In some examples, operations performed by a cloud computing network, and or any components included therein, may be supported by one or more devices similar to device 1100. Stated otherwise, some or all of the operations performed by the cloud computing network, and or any components included therein, may be performed by a device 1100 or multiple operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1118 can store an operating system 1120 utilized to control the operation of the device 1100. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1118 can store other system or application programs and data utilized by the device 1100.

In many additional embodiments, the storage 1118 or other computer-readable storage media is encoded with computer-executable instructions which, when loaded into the device 1100, may transform it from a general-purpose computing system into a special-purpose computer capable of implementing the embodiments described herein. These computer-executable instructions may be stored as application and transform the device 1100 by specifying how the processor(s) 1104 can transition between states, as described above. In some embodiments, the device 1100 has access to computer-readable storage media storing computer-executable instructions which, when executed by the device 1100, perform the various processes described above with regard to FIGS. 1-10. In certain embodiments, the device 1100 can also include computer-readable storage media having instructions stored thereupon for performing any of the other computer-implemented operations described herein.

In many embodiments, the storage 1118 may contain a coordinated triggered uplink access logic 1124. The coordinated triggered uplink access logic 1124 may be configured to manage the network device's 1100 participation in a multi-access point (AP) coordination (MAPC) group. In a leader AP role, the coordinated triggered uplink access logic 1124 may exchange C-TUA capabilities with a second, follower AP, coordinate an uplink transmission time associated with the follower AP's service period (SP), and receive information identifying one or more wireless devices associated with that follower AP. The coordinated triggered uplink access logic 1124 may then transmit a proxy trigger frame on behalf of the follower AP at the coordinated time to instruct those wireless devices to transmit their uplink data, which is received directly by the follower AP. In a follower AP role, the coordinated triggered uplink access logic 1124 may provide its own wireless device information to a leader AP, monitor for the proxy trigger, and activate its receiver to capture the uplink data from its wireless devices when triggered.

Furthermore, the coordinated triggered uplink access logic 1124 may be configured to establish and manage enhanced triggered uplink access (E-TUA) groups for its own associated wireless devices. The coordinated triggered uplink access logic 1124 may identify a plurality of wireless devices with similar predictable traffic, such as from received stream classification service (SCS) quality of service characteristics (QC) signaling or learned traffic periodicity. After establishing a group, the coordinated triggered uplink access logic 1124 may transmit a group announcement message defining uplink parameters (e.g., a fixed resource unit (RU) allocation or service interval (SI)) and assigning a group identifier (GID). Subsequently, the coordinated triggered uplink access logic 1124 may transmit a highly efficient enhanced trigger frame, which comprises the GID and omits per-wireless device user information, to command the entire group to transmit.

In various embodiments, the TUA group data 1128 may comprise one or more data structures, tables, or databases configured to store information related to established triggered uplink access (TUA) groups. This TUA group data 1128 may store entries for a plurality of TUA groups, where each entry is associated with a specific group identifier (GID) that may be selected from an available association identifier (AID) space. For each TUA group, the TUA group data 1128 may store a list of the member wireless devices (e.g., by their AIDs) that belong to that group, as well as the specific uplink parameters defined for the group during its establishment. These stored uplink parameters, which may be communicated to devices in a group announcement message, can include a firm-fixed service interval (SI), a high-probability fixed resource unit (RU) allocation for each member, and a high-probability modulation and coding scheme (MCS). In some embodiments, the TUA group data 1128 may also store information associating a TUA group with other network mechanisms, such as a broadcast target wake time (TWT) group.

The coordinated triggered uplink access logic 1124 may utilize the TUA group data 1128 to manage the operation of enhanced TUA (E-TUA). When the coordinated triggered uplink access logic 1124 determines it is time to trigger a group based on the service interval (SI) stored in the TUA group data 1128, it may retrieve the corresponding GID from this TUA group data 1128. This GID is then placed into an enhanced trigger frame, which may omit per-wireless device user information, for transmission. On a network device 1100 operating as a wireless device, the coordinated triggered uplink access logic 1124 may query its local TUA group data 1128 (received from an AP) to determine its GID and its pre-defined uplink resources upon receiving a valid enhanced trigger frame. In a multi-AP C-TUA context, a follower AP's coordinated triggered uplink access logic 1124 may access the TUA group data 1128 to retrieve a GID to provide to a leader AP as part of its wireless device information exchange.

In various embodiments, the MAPC data 1130 may comprise one or more data structures storing information related to the access point's 1100 participation in a multi-AP coordination (MAPC) group. This MAPC data 1130 may store a list of member access points (APs) within the MAPC group, their roles (e.g., leader or follower), and the exchanged coordinated triggered uplink access (C-TUA) capabilities of each member. These stored capabilities may indicate support for receiving proxy triggers, support for specific identifier types like association identifiers (AIDs) or group identifiers (GIDs), or support for control frame protection. Furthermore, the MAPC data 1130 may store the negotiated service period (SP) sharing schedules, such as coordinated uplink transmission times or target traffic start times (TTST), and the wireless device information received from follower APs, such as their AIDs or TUA GIDs. In some embodiments, the MAPC data 1130 may also store a shared MAPC coordination group (CG) address (e.g., a MAC address) used for transmitting proxy triggers.

The coordinated triggered uplink access logic 1124 may utilize the MAPC data 1130 to execute multi-AP coordination. When operating as a leader AP, the coordinated triggered uplink access logic 1124 may query the MAPC data 1130 to identify a follower AP, retrieve its negotiated SP schedule, and obtain the necessary wireless device identifiers to construct and transmit a proxy trigger frame at the coordinated uplink transmission time. The coordinated triggered uplink access logic 1124 may also access this MAPC data 1130 to determine if a shared MAPC CG address should be used as the transmitter address for the proxy trigger frame or if advanced features like coordinated spatial reuse (C-SR) are supported by the intended follower APs. When operating as a follower AP, the coordinated triggered uplink access logic 1124 may access the MAPC data 1130 to provide its own device information during negotiation or to retrieve the MAPC CG info (e.g., authorized BSSIDs or the CG address) to send to its associated wireless devices, enabling them to validate incoming proxy triggers.

In various embodiments, the traffic characteristics data 1132 may comprise one or more data structures, tables, or databases configured to store parameters related to uplink traffic flows from one or more wireless devices. This traffic characteristics data 1132 may be populated from explicit signaling received from the wireless devices, such as stream classification service (SCS) quality of service (QoS) characteristics (QC) signaling, or it may be populated from parameters determined by the device 1100 itself, such as through traffic monitoring or inspection to determine a learned traffic periodicity. The stored characteristics may include, for example, predictable service intervals (SIs), minimum and maximum service intervals, data rate requirements, data size per period, traffic class information, and traffic arrival times or target traffic start times (TTST).

The coordinated triggered uplink access logic 1124 may utilize the traffic characteristics data 1132 to manage and optimize uplink transmissions. The coordinated triggered uplink access logic 1124 may query this traffic characteristics data 1132 to identify a plurality of wireless devices that have similar predictable traffic, which may serve as a basis for establishing a triggered uplink access (TUA) group. For instance, the coordinated triggered uplink access logic 1124 may identify multiple devices sharing the same service interval (e.g., for XR uplink pose data) and determine they are suitable for a TUA group. In a multi-AP coordination (MAPC) context, the coordinated triggered uplink access logic 1124 (operating as a follower AP) may also use the stored service interval and TTST information from this traffic characteristics data 1132 to negotiate service period (SP) sharing with a leader AP.

In still further embodiments, the device 1100 can also include one or more input/output controllers 1116 for receiving and processing input from a number of input devices, such as a keyboard, a mouse, a touchpad, a touch screen, an electronic stylus, or other type of input device. Similarly, input/output controllers 1116 can be configured to provide output to a display, such as a computer monitor, a flat panel display, a digital projector, a printer, or other type of output device. Those skilled in the art will recognize that the device 1100 might not include all of the components shown in FIG. 11 and can include other components that are not explicitly shown in FIG. 11 or might utilize an architecture completely different than that shown in FIG. 11.

As described above, the device 1100 may support a virtualization layer, such as one or more virtual resources executing on the device 1100. In some examples, the virtualization layer may be supported by a hypervisor that provides one or more virtual machines running on the device 1100 to perform functions described herein. The virtualization layer may generally support a virtual resource that performs at least a portion of the techniques described herein.

Finally, in numerous additional embodiments, data may be processed into a format usable by one or more machine-learning models 1126 (e.g., feature vectors), and or other pre-processing techniques. The machine-learning (“ML”) models 1126 may be any type of ML model, such as supervised models, reinforcement models, and/or unsupervised models. The ML models 1126 may include one or more of linear regression models, logistic regression models, decision trees, Naïve Bayes models, neural networks, k-means cluster models, random forest models, and/or other types of ML models 1126.

In various embodiments, the machine-learning model(s) 1126 may comprise one or more predictive models, such as time-series forecasting models, clustering algorithms, or regression models, that have been trained on historical network data, such as the traffic characteristics data 1132. The coordinated triggered uplink access logic 1124 may utilize the machine-learning model(s) 1126 to perform the “traffic period learning” for low-quality of service (QoS) or unknown applications. For example, the machine-learning model(s) 1126 may analyze traffic flows, potentially through deep packet inspection or traffic monitoring, to learn the periodicity, service interval (SI), and data size of uplink transmissions from wireless devices that have not provided explicit stream classification service (SCS) quality of service characteristics (QC) signaling. This “learned traffic periodicity” generated by the machine-learning model(s) 1126 can then be used by the coordinated triggered uplink access logic 1124 as a basis for identifying and establishing a triggered uplink access (TUA) group.

Although a specific embodiment for one or more network devices 1100 for carrying out the various steps, processes, methods, and operations described herein is discussed with respect to FIG. 11, any of a variety of systems and/or devices may be utilized in accordance with embodiments of the disclosure. For example, the coordinated triggered uplink access logic 1124 could be implemented partially or wholly within dedicated hardware circuitry, such as an application-specific integrated circuit (ASIC). The elements depicted in FIG. 11 may also be interchangeable with other elements of FIGS. 1-10 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. An access point, comprising:
a processor;
at least one network interface controller configured to provide access to a network with a plurality of access points (APs); and
a memory communicatively coupled to the processor, wherein the memory comprises a coordinated triggered uplink access (C-TUA) logic that is configured to:
exchange, via the at least one network interface controller, one or more C-TUA capabilities with a second, follower AP within a multi-AP coordination (MAPC) group;
coordinate an uplink transmission time associated with a service period (SP) of the second, follower AP;
receive, from the second, follower AP, information identifying at least one wireless device associated with the second, follower AP; and
transmit a proxy trigger frame on behalf of the second, follower AP at the uplink transmission time.

2. The access point of claim 1, wherein the proxy trigger frame comprises an identifier.

3. The access point of claim 2, wherein the identifier corresponds to the at least one wireless device associated with the second, follower AP.

4. The access point of claim 3, wherein the identifier instructs the at least one wireless device to transmit uplink data.

5. The access point of claim 4, wherein the transmission of the uplink data is directly to the second, follower AP.

6. The access point of claim 1, wherein the one or more C-TUA capabilities exchanged indicate whether the second, follower AP supports C-TUA operation.

7. The access point of claim 1, wherein the one or more C-TUA capabilities exchanged indicate whether the second, follower AP supports receiving proxy trigger frames from the access point.

8. The access point of claim 1, wherein the one or more C-TUA capabilities exchanged indicate whether the second, follower AP supports triggering via shared association identifiers (AIDs) or group identifiers (GIDs).

9. The access point of claim 1, wherein the one or more C-TUA capabilities exchanged indicate whether the second, follower AP supports control frame protection for proxy trigger frames.

10. The access point of claim 1, wherein the proxy trigger frame uses a multi-AP coordination (MAPC) coordination group (CG) address as a transmitter address.

11. The access point of claim 1, wherein the coordinated triggered uplink access (C-TUA) logic is further configured to transmit the proxy trigger frame simultaneously to wireless devices associated with the second, follower AP and wireless devices associated with a third, follower AP using coordinated spatial reuse (C-SR).

12. An access point, comprising:
a processor;
at least one network interface controller configured to provide access to a network; and
a memory communicatively coupled to the processor, wherein the memory comprises a coordinated triggered uplink access (C-TUA) logic that is configured to:
establish a triggered uplink access (TUA) group comprising a plurality of wireless devices;
transmit, via the at least one network interface controller, a group announcement message defining uplink parameters for the TUA group; and
transmit, via the at least one network interface controller, an enhanced trigger frame comprising a group identifier (GID) for the TUA group.

13. The access point of claim 12, wherein the enhanced trigger frame omits per-wireless device user information for the plurality of wireless devices included in the TUA group.

14. The access point of claim 12, wherein the coordinated triggered uplink access (C-TUA) logic establishes the triggered uplink access (TUA) group based on explicit stream classification service quality of service characteristics (SCS QC) signaling received from the plurality of wireless devices or based on learned traffic periodicity of the plurality of wireless devices.

15. The access point of claim 12, wherein the uplink parameters defined in the group announcement message include at least one of a fixed service interval (SI), a fixed resource unit (RU) allocation, or a fixed modulation and coding scheme (MCS) for the TUA group.

16. The access point of claim 12, wherein the enhanced trigger frame further comprises a compressed common information field.

17. The access point of claim 12, wherein the group identifier (GID) is selected from an association identifier (AID) space utilized by the access point.

18. The access point of claim 12, wherein the triggered uplink access (TUA) group is associated with a broadcast target wake time (TWT) group.

19. A method of access point (AP) coordination, comprising:
exchanging, via a network interface controller, one or more C-TUA capabilities with a follower AP within a multi-AP coordination (MAPC) group;
coordinating an uplink transmission time associated with a service period (SP) of the follower AP;
receiving, from the follower AP, information identifying at least one wireless device associated with the follower AP; and
transmitting a proxy trigger frame on behalf of the follower AP at the uplink transmission time.

20. The method of claim 19, wherein the method is carried out by a leader AP device.
